(19) United States
(12) Patent Application Publication
(10) Pub. No.: US 2026/0255185 A1
(43) Pub. Date: Aug. 27, 2026

(54) SYSTEM

(71) Applicant: SoftBank Group Corp., Tokyo (JP)

(72) Inventor: Hirotaka OMAGARI, Tokyo (JP)

(73) Assignee: SoftBank Group Corp., Tokyo (JP)

(21) Appl. No.: 19/541,427

(22) Filed: Feb. 17, 2026

(30) Foreign Application Priority Data
Feb. 21, 2025 (JP) 2025-026998

(51) Int. Cl. H04W 24/02; G01C 21/36; G06F 40/284; G06F 40/58; G06V 10/82; G06V 20/52; G10L 15/26; G10L 25/30; G10L 25/63; H04W 24/08

(52) U.S. Cl. CPC H04W 24/02; G01C 21/3602; G06F 40/284; G06F 40/58; G06V 10/82; G06V 20/52; G10L 15/26; G10L 25/30; G10L 25/63; H04W 24/08

(57) ABSTRACT

The system according to the embodiment comprises an installation unit, a provision unit, a wireless LAN unit, and an advertisement unit. The installation unit installs digital signage. The provision unit provides information in multiple languages using the digital signage installed by the installation unit. The wireless LAN unit provides wireless LAN. The advertisement unit distributes advertisements.

### CROSS-REFERENCE TO RELATED APPLICATION

The present application claims priority to and incorporates by reference the entire contents of Japanese Patent Application No. 2025-026998 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, the provision of information in multiple languages and wireless LAN in public places such as bus stops has not been sufficiently implemented, and there is room for improvement.

### SUMMARY OF THE INVENTION

The system according to the embodiment comprises an installation unit, a provision unit, a wireless LAN unit, and an advertisement unit. The installation unit installs digital signage. The provision unit provides information in multiple languages using the digital signage installed by the installation unit. The wireless LAN unit provides wireless LAN. The advertisement unit distributes advertisements.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

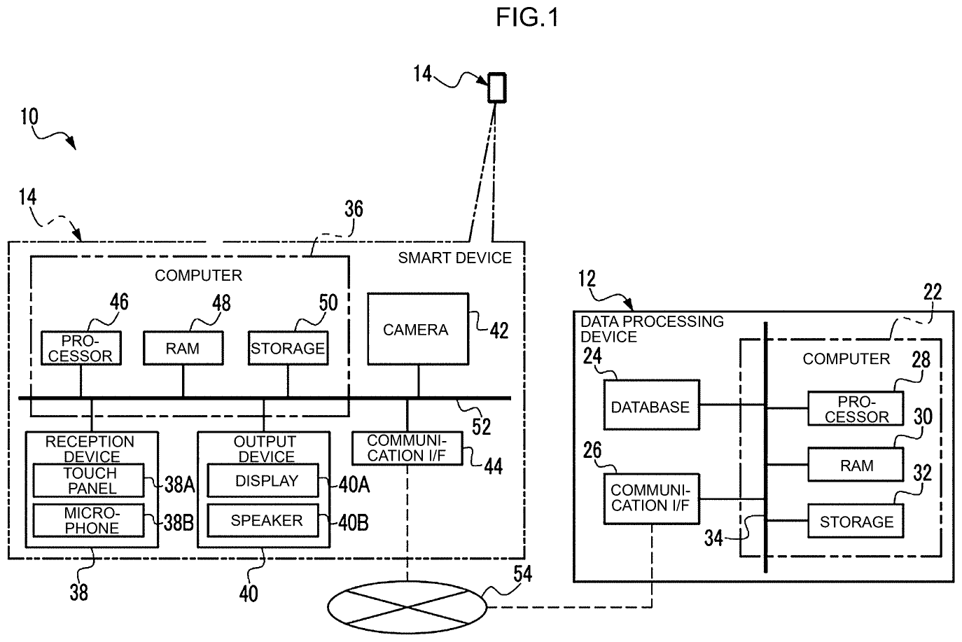

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

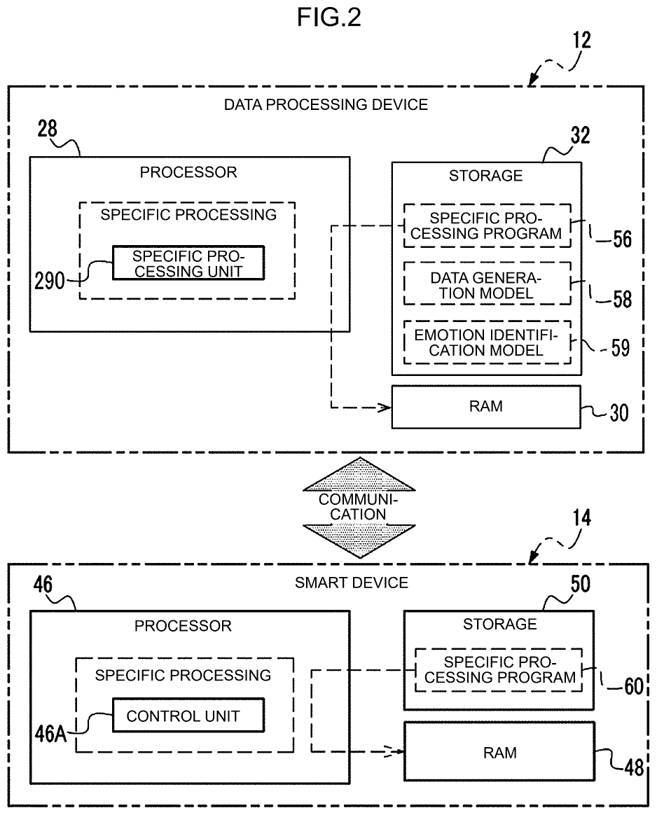

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The AI roadside concierge system according to the embodiment of the present invention is a system that utilizes digital signage to convert bus stops into signage, thereby providing various concierge services in multiple languages, such as tourist guidance, hospital guidance, ATM guidance, and restroom guidance. This system enables users to obtain necessary information without having to look at a small smartphone. Furthermore, by providing wireless LAN at bus stops, the use of smartphones is promoted, and by distributing advertisements, revenue can be increased. As a result, the value of utilizing buses is enhanced, and a business model that eliminates waiting times is realized. For example, digital signage is installed at bus stops, and AI provides various concierge services in multiple languages, such as tourist guidance, hospital guidance, ATM guidance, and restroom guidance. When a tourist approaches the digital signage installed at a bus stop, AI provides information about tourist spots and guides the way to the nearest tourist destination. In addition, for users searching for hospitals, information about the nearest hospital is provided, including departments and consultation hours. Furthermore, for users searching for ATMs or restrooms, the locations of the nearest ATM or restroom are guided. Next, by providing wireless LAN at bus stops, users can more easily use their smartphones. This allows users to connect to the Internet at bus stops and search for necessary information on their smartphones. In addition, advertisements can be distributed to digital signage using wireless LAN. For example, advertisements are displayed on digital signage installed at bus stops, providing users with information about products and services. This increases advertising revenue. Furthermore, to make effective use of waiting time at bus stops, entertainment content can be provided using digital signage. For example, movie trailers or music videos can be played on digital signage installed at bus stops for users to enjoy. In addition, by displaying bus arrival times in real time, users can obtain other information while waiting for the bus to arrive. In this way, the AI roadside concierge system improves user convenience by utilizing digital signage to convert bus stops into signage and providing various concierge services in multiple languages, such as tourist guidance, hospital guidance, ATM guidance, and restroom guidance. Furthermore, by providing wireless LAN at bus stops, the use of smartphones is promoted, and by distributing advertisements, revenue can be increased. As a result, the value of utilizing buses is enhanced, and a business model that eliminates waiting times is realized. Thus, the AI roadside concierge system can improve user convenience and increase revenue. Specifically, the AI roadside concierge system links multiple computer modules (installation unit, provision unit, wireless LAN unit, advertisement unit), and by operating each module as an independent process, it realizes real-time and personalized information provision, which is different from conventional human guidance operations or simple information posting. In this system, the installation unit physically installs digital signage terminals (including high-brightness LCD displays, touch panels, sensor units, etc.) at bus stops and their surroundings, and the provision unit analyzes user input (voice, text, image, location information, device information, etc.) using large-scale language models and multilingual neural networks (for example, Transformer-based multilingual models or multimodal models that integrally handle images, voice, and text) on the cloud. For example, when a user asks “Where is the nearest ATM?” in Japanese, the voice recognition engine converts the voice waveform data (sampling rate 16 kHz, 16,000 samples per second, one-dimensional array) into text, which is then provided as an input tensor (token ID sequence, maximum length 512) to the multilingual model. The model generates multilingual text as output (e.g., “The nearest ATM is 100 meters ahead on your right.” or “ [symbol] [symbol] ”), and also outputs structured data for map images and route guidance (in JSON format including coordinates and landmark information). These outputs are not only displayed on the signage screen by the provision unit, but are also used for push notifications to user devices and voice synthesis for reading aloud. In the case of hospital guidance, the user's health status and past usage history (linked electronic medical records and past search history database) are referenced, and departments and consultation hours are dynamically filtered and presented. ATM guidance and restroom guidance similarly use location information (GPS coordinates, Wi-Fi triangulation results, etc.) as input, and present the optimal facilities ranked. The wireless LAN unit controls access points compatible with the latest standards such as IEEE 802.11ax, monitors user device MAC addresses, connection history, battery level, application type, etc. in real time, and optimizes bandwidth allocation and connection priority using AI. The advertisement unit uses user attribute information (age group, gender, past advertisement viewing history, current location, emotion estimation results, etc.) as input, and selects and distributes optimal advertisement content (videos, still images, coupons, etc.) using advertisement recommendation models (e.g., reinforcement learning-based bandit algorithms or RNN-based recommendation models that take user behavior sequences as input). Examples of input to AI include structured data such as “female in her 30s, used tourist guidance three times in the past week, current location is in front of the station, emotion estimation is relaxed,” or voice data where the user says “ATM.” Examples of AI output include “ATM guidance text (Japanese/English),” “map image of the nearest ATM,” “video URL for a cafe advertisement for relaxation,” etc. These outputs are used for subsequent processing such as threshold judgment (e.g., display only when advertisement click rate exceeds a certain value) and branching (e.g., prioritize restroom guidance when emotion is stress). As a technical effect, this system improves computer technology itself by providing real-time and multilingual optimized information, advertisement, and communication services for each user, compared to conventional static information posting or human guidance, resulting in improved user experience, maximized advertising revenue, efficient use of communication resources, and reduced operational costs. Specific application fields include bus stops at tourist destinations, airports, train stations, shopping malls, hospitals, public facilities, and the advancement of multilingual guidance, advertisement, and communication services in all public spaces. Furthermore, variations of AI models include configurations that link multiple models such as voice recognition, emotion estimation, image recognition, recommendation, and translation, cloud-edge cooperative processing, anonymization processing for user privacy protection, and security enhancement through anomaly detection, enabling diverse embodiments.

The AI roadside concierge system according to the embodiment comprises an installation unit, a provision unit, a wireless LAN unit, and an advertisement unit. The installation unit installs digital signage. The digital signage is installed, for example, at bus stops, but is not limited to such examples. The installation unit can install digital signage in bus stop waiting rooms or around bus stops, for example. The provision unit provides information in multiple languages using the digital signage installed by the installation unit. The provision unit provides information such as tourist guidance, hospital guidance, ATM guidance, and restroom guidance in multiple languages, for example. For example, when a tourist approaches the digital signage installed at a bus stop, the provision unit provides information about tourist spots and guides the way to the nearest tourist destination. In addition, for users searching for hospitals, the provision unit provides information about the nearest hospital, including departments and consultation hours. Furthermore, for users searching for ATMs or restrooms, the provision unit guides the location of the nearest ATM or restroom. The provision unit can use AI to provide information such as tourist guidance, hospital guidance, ATM guidance, and restroom guidance in multiple languages. AI can use, for example, text generation AI (such as LLM) to generate information such as tourist guidance, hospital guidance, ATM guidance, and restroom guidance. The wireless LAN unit provides wireless LAN at bus stops. The wireless LAN unit can provide wireless LAN in bus stop waiting rooms or around bus stops, for example. The wireless LAN unit can provide wireless LAN compliant with the IEEE 802.11 standard, for example. The wireless LAN unit provides wireless LAN at bus stops to facilitate the use of smartphones by users, for example. The advertisement unit distributes advertisements to digital signage. The advertisement unit displays advertisements on digital signage installed at bus stops, for example, and provides users with information about products and services. The advertisement unit can distribute advertisements such as video advertisements, banner advertisements, and targeted advertisements, for example. As a result, the AI roadside concierge system according to the embodiment enables multilingual information provision, wireless LAN provision, and advertisement distribution using digital signage. Some or all of the above-described processing in the advertisement unit may be performed using AI, or may be performed without using AI. For example, the advertisement unit can distribute advertisements using an AI model that takes user attribute information as input and outputs advertisement content. Specifically, the AI roadside concierge system physically installs digital signage terminals including high-brightness LCD displays, touch panels, and sensor units by the installation unit, and analyzes user input (voice, text, image, location information, device information, etc.) using large-scale language models and multilingual neural networks (for example, Transformer-based multilingual models or multimodal models that integrally handle images, voice, and text) on the cloud by the provision unit. For example, when a user asks “Where is the nearest ATM?” in Japanese, the provision unit converts the voice waveform data (sampling rate 16 kHz, 16,000 samples per second, one-dimensional array) into text using a voice recognition engine, and provides it as an input tensor (token ID sequence, maximum length 512) to the multilingual model. The model generates multilingual text as output (e.g., “The nearest ATM is 100 meters ahead on your right.” or “ [symbol] ”), and also outputs structured data for map images and route guidance (in JSON format including coordinates and landmark information). These outputs are not only displayed on the signage screen by the provision unit, but are also used for push notifications to user devices and voice synthesis for reading aloud. In the case of hospital guidance, the user's health status and past usage history (linked electronic medical records and past search history database) are referenced, and departments and consultation hours are dynamically filtered and presented. ATM guidance and restroom guidance similarly use location information (GPS coordinates, Wi-Fi triangulation results, etc.) as input, and present the optimal facilities ranked. The wireless LAN unit controls access points compatible with the latest standards such as IEEE 802.11ax, monitors user device MAC addresses, connection history, battery level, application type, etc. in real time, and optimizes bandwidth allocation and connection priority using AI. The advertisement unit uses user attribute information (age group, gender, past advertisement viewing history, current location, emotion estimation results, etc.) as input, and selects and distributes optimal advertisement content (videos, still images, coupons, etc.) using advertisement recommendation models (e.g., reinforcement learning-based bandit algorithms or RNN-based recommendation models that take user behavior sequences as input). Examples of input to AI include structured data such as “female in her 30s, used tourist guidance three times in the past week, current location is in front of the station, emotion estimation is relaxed,” or voice data where the user says “ATM.” Examples of AI output include “ATM guidance text (Japanese/English),” “map image of the nearest ATM,” “video URL for a cafe advertisement for relaxation,” etc. These outputs are used for subsequent processing such as threshold judgment (e.g., display only when advertisement click rate exceeds a certain value) and branching (e.g., prioritize restroom guidance when emotion is stress). As a technical effect, this system improves computer technology itself by providing real-time and multilingual optimized information, advertisement, and communication services for each user, compared to conventional static information posting or human guidance, resulting in improved user experience, maximized advertising revenue, efficient use of communication resources, and reduced operational costs. Specific application fields include bus stops at tourist destinations, airports, train stations, shopping malls, hospitals, public facilities, and the advancement of multilingual guidance, advertisement, and communication services in all public spaces. Furthermore, variations of AI models include configurations that link multiple models such as voice recognition, emotion estimation, image recognition, recommendation, and translation, cloud-edge cooperative processing, anonymization processing for user privacy protection, and security enhancement through anomaly detection, enabling diverse embodiments.

The provision unit can provide information on tourist guidance, hospital guidance, ATM guidance, and restroom guidance in multiple languages. For example, the provision unit provides tourist guidance in multiple languages. Tourist guidance includes, for example, information about tourist spots, directions to tourist spots, and business hours of tourist spots, but is not limited to such examples. The provision unit provides hospital guidance in multiple languages, for example. Hospital guidance includes, for example, information about the nearest hospital, departments, and consultation hours, but is not limited to such examples. The provision unit provides ATM guidance in multiple languages, for example. ATM guidance includes, for example, the location of the nearest ATM, available hours, and available services, but is not limited to such examples. The provision unit provides restroom guidance in multiple languages, for example. Restroom guidance includes, for example, the location of the nearest restroom, available hours, and available facilities, but is not limited to such examples. As a result, the provision unit improves user convenience by providing information in multiple languages. Specifically, the provision unit utilizes large-scale language models and multimodal neural networks that support multiple languages (for example, Transformer-based multilingual models or models that integrally handle images, voice, and text) running on the cloud or edge servers, and receives input data from users (voice data: one-dimensional array sampled at 16 kHz, text data: ID sequence of up to 512 tokens, image data: 224×224 pixel RGB tensor, location information: numerical vector of latitude and longitude, device information: structured data including OS type and language settings, etc.). For example, when a user says “Tell me the nearest sightseeing spot” in Japanese, the provision unit converts the voice waveform into text using a voice recognition engine and provides it as an input tensor to the multilingual model. The model generates multilingual text as output (e.g., “The nearest sightseeing spot is the City Museum.” or “ [symbol] [symbol] ”), a map image of the tourist spot (PNG format image tensor), and structured data including business hours and access information (in JSON format storing facility name, address, business hours, route information, etc.). In the case of hospital guidance, the provision unit references the user's health status and past usage history (linked electronic medical record database or search history) and dynamically filters and presents departments and consultation hours. In the case of ATM guidance or restroom guidance, location information (GPS coordinates or Wi-Fi triangulation results) is used as input, and the optimal facilities are ranked and presented. Examples of AI output include “ATM guidance text (Japanese/English),” “map image of the nearest ATM,” and “multilingual text for restroom guidance.” These outputs are not only displayed on the signage screen by the provision unit, but are also used for push notifications to user devices and voice synthesis for reading aloud. As subsequent processing, the provision unit automatically switches the display language and format according to the user's language settings and device type, and optimizes the level of detail and display method of information according to the user's emotion estimation results (relaxed, in a hurry, stressed, etc.). As a technical effect, the provision unit improves computer technology itself by realizing real-time and personalized multilingual information provision, which is different from conventional static bulletin boards or human guidance, resulting in improved user experience, faster information acquisition, reduced misguidance, and reduced operational costs. Specific application fields include bus stops at tourist destinations, airports, train stations, shopping malls, hospitals, public facilities, and the advancement of multilingual guidance services in all public spaces. Furthermore, variations of AI models include configurations that link multiple models such as voice recognition, emotion estimation, image recognition, translation, cloud-edge cooperative processing, anonymization processing for user privacy protection, and security enhancement through anomaly detection, enabling diverse embodiments.

The wireless LAN unit provides wireless LAN at bus stops, making it easier for users to use smartphones. The wireless LAN unit provides wireless LAN in bus stop waiting rooms or around bus stops, for example. The wireless LAN unit can provide wireless LAN compliant with the IEEE 802.11 standard, for example. The wireless LAN unit provides wireless LAN at bus stops to facilitate the use of smartphones by users, for example. The wireless LAN unit can expand the coverage area of wireless LAN to make it easier for users at bus stops to connect to the Internet. As a result, the wireless LAN unit makes it easier for users to use smartphones by providing wireless LAN. Specifically, the wireless LAN unit physically installs high-performance access points compatible with the latest standards such as IEEE 802.11ax and Wi-Fi 6E in bus stop waiting rooms and surrounding areas, and implements algorithms that automatically optimize the installation position, channel, output power, and antenna directivity of each access point. When the wireless LAN unit receives a connection request from a user device, it collects metadata such as the device's MAC address, OS type, battery level, application type, and location information (GPS or Wi-Fi triangulation) in real time, and uses AI models (for example, reinforcement learning-based bandwidth allocation optimization models or clustering models that take device attributes as input) to dynamically determine bandwidth allocation, connection priority, access point selection, and QoS parameters (latency, packet loss tolerance, etc.). Examples of input to AI include “smartphone, battery level 20%, using video streaming app, current location is north side of bus stop,” “tablet, battery level 80%, browsing the web, current location is inside waiting room,” etc. Examples of AI output include “connection permission to AP1, bandwidth allocation 20 Mbps,” “connection permission to AP2, high priority, QoS setting: latency below 50 ms,” etc. As subsequent processing, the wireless LAN unit issues control signals to access points based on AI output, and automatically executes connection permission, bandwidth allocation, connection disconnection, and reconnection instructions to user devices. Furthermore, the wireless LAN unit monitors user movement routes and congestion status in real time, and optimizes handover and load balancing between access points using AI. As a technical effect, the wireless LAN unit improves computer technology itself by realizing dynamic optimization according to user attributes and usage status, which is different from conventional fixed wireless LAN provision methods, resulting in improved communication quality, reduced connection drop rate, efficient use of bandwidth resources, improved user experience, and reduced operational costs. Specific application fields include bus stops at tourist destinations, airports, train stations, shopping malls, hospitals, public facilities, and the advancement of wireless communication services in all public spaces. Furthermore, variations of AI models include security enhancement through anomaly detection, anonymization processing for user privacy protection, and load balancing through edge-cloud cooperation, enabling diverse embodiments.

The advertisement unit distributes advertisements to digital signage and can increase advertising revenue. The advertisement unit displays advertisements on digital signage installed at bus stops, for example. The advertisement unit can distribute advertisements such as video advertisements, banner advertisements, and targeted advertisements, for example. The advertisement unit can adjust the content of advertisements to provide users with information about products and services, for example. The advertisement unit can distribute targeted advertisements based on user attribute information, for example. As a result, the advertisement unit can increase advertising revenue. Specifically, the advertisement unit uses user attribute information (age group, gender, past advertisement viewing history, current location, emotion estimation results, device type, etc.) and behavioral history (past clicks, purchases, dwell time, etc.) as input, and selects and distributes optimal advertisement content (videos, still images, coupons, interactive advertisements, etc.) using advertisement recommendation AI models (for example, reinforcement learning-based bandit algorithms, RNN-based recommendation models that take user behavior sequences as input, multimodal recommendation models that integrally handle image, text, and behavioral data, etc.). Examples of input to AI include “female in her 30s, used tourist guidance three times in the past week, current location is in front of the station, emotion estimation is relaxed,” “male in his 20s, clicked on cafe advertisements three times in the past, current location is south side of bus stop,” etc. Examples of AI output include “video URL for a cafe advertisement for relaxation,” “banner image for a station-front limited coupon,” “interactive advertisement for a newly opened store,” etc. The advertisement unit displays advertisements on signage screens, sends push notifications to user devices, optimizes advertisement display frequency and timing, and performs real-time analysis of advertisement effectiveness (click rate, dwell time, conversion rate, etc.) based on AI output. As subsequent processing, the advertisement unit performs threshold judgment and branching based on advertisement click rate and user response (e.g., continue displaying only advertisements clicked more than a certain number of times, reduce advertisement frequency when emotion is stress). As a technical effect, the advertisement unit improves computer technology itself by realizing real-time and multilingual optimized advertisement distribution for each user, which is different from conventional uniform distribution-type advertisements, resulting in maximized advertising revenue, improved user experience, visualization of advertisement effectiveness, and reduced operational costs. Specific application fields include bus stops at tourist destinations, airports, train stations, shopping malls, hospitals, public facilities, and the advancement of advertisement distribution services in all public spaces. Furthermore, variations of AI models include linkage of multiple models such as emotion estimation, image recognition, and behavior prediction, cloud-edge cooperative processing, anonymization processing for user privacy protection, and elimination of fraudulent advertisements through anomaly detection, enabling diverse embodiments.

The provision unit can display bus arrival times in real time. For example, the provision unit displays bus arrival times in real time. Real-time display includes, for example, updates in seconds or minutes, but is not limited to such examples. By displaying bus arrival times in real time, users can obtain other information while waiting for the bus to arrive. As a result, the provision unit improves user convenience by displaying bus arrival times in real time. Specifically, the provision unit periodically acquires current position data of buses (numerical vectors of latitude, longitude, speed, route ID, etc.) from bus operation management systems or GPS tracking servers, and uses arrival prediction AI models (for example, LSTM or GRU-based recurrent neural networks for time series prediction, or Transformer-based time series models) to generate predicted arrival times for each bus stop (UNIX timestamp or text such as “in 3 minutes”). Examples of input to AI include “bus ID: 1234, current location: latitude 35.1234, longitude 139.5678, speed: 20 km/h, route ID: A1,” “bus ID: 5678, current location: latitude 35.5678, longitude 139.1234, speed: 15 km/h, route ID: B2,” etc. Examples of AI output include “arrival prediction: in 2 minutes,” “arrival prediction: in 5 minutes,” etc. The provision unit displays these outputs on the signage screen in real time and automatically updates them in seconds or minutes. Furthermore, they can be used for push notifications to user devices and voice synthesis for reading aloud. As subsequent processing, the provision unit automatically detects bus delays or service suspensions and displays warnings or guides alternative transportation as necessary. As a technical effect, the provision unit improves computer technology itself by realizing real-time and highly accurate arrival prediction, which is different from conventional timetable-based static display, resulting in reduced waiting times for users, faster information acquisition, reduced misguidance, and more efficient operation management. Specific application fields include bus stops at tourist destinations, airports, train stations, shopping malls, hospitals, public facilities, and the advancement of real-time guidance services for all public transportation. Furthermore, variations of AI models include automatic detection of delays and service suspensions through anomaly detection, simultaneous prediction of multiple routes and buses, and personalized display according to the user's current location and destination, enabling diverse embodiments.

The provision unit can provide entertainment content. For example, the provision unit plays movie trailers or music videos on digital signage installed at bus stops. Entertainment content includes, for example, videos, music, games, etc., but is not limited to such examples. The provision unit can provide entertainment content for users to enjoy, for example. As a result, the provision unit enables effective use of waiting time by providing entertainment content. Specifically, the provision unit acquires digital content such as video files (e.g., MP4 format, resolution 1920×1080, bitrate 5 Mbps), music files (e.g., MP3 format, sampling rate 44.1 kHz), and interactive game apps (HTML5 or Unity-based) from cloud content distribution servers or local storage, and uses AI models (for example, RNN or Transformer-based models for content recommendation) that take user attribute information (age group, language settings, past viewing history, emotion estimation results, etc.) and device type (signage screen, smartphone, tablet, etc.) as input to select and distribute optimal entertainment content. Examples of input to AI include “male in his teens, watched music videos five times in the past, current location is south side of bus stop,” “female in her 30s, emotion estimation is relaxed, watched movie trailers three times in the past,” etc. Examples of AI output include “URL for the latest movie trailer video,” “playlist of relaxing music,” “launch link for interactive quiz game,” etc. The provision unit displays and plays these outputs on the signage screen, and can also use them for push notifications to user devices and voice synthesis for guidance. As subsequent processing, the provision unit collects user reactions (view completion rate, game score, playback count, etc.) in real time and updates the parameters of the content recommendation model through online learning. As a technical effect, the provision unit improves computer technology itself by realizing real-time optimized entertainment experiences for each user, which is different from conventional uniform content distribution, resulting in effective use of waiting time, improved user satisfaction, promotion of content consumption, and increased advertising revenue. Specific application fields include bus stops at tourist destinations, airports, train stations, shopping malls, hospitals, public facilities, and the advancement of entertainment services in all public spaces. Furthermore, variations of AI models include linkage of multiple models such as emotion estimation, image recognition, and behavior prediction, cloud-edge cooperative processing, anonymization processing for user privacy protection, and elimination of inappropriate content through anomaly detection, enabling diverse embodiments.

The installation unit can estimate a user's emotion and optimize the installation location of the digital signage based on the estimated emotion of the user. For example, if the user is feeling stressed, the installation unit installs digital signage in a quiet location. If the user is relaxed, the installation unit can install digital signage in a lively location. If the user is in a hurry, the installation unit can install digital signage near the bus stop. As a result, the installation unit improves user convenience by optimizing the installation location based on the user's emotion. Emotion estimation is realized using, for example, an emotion engine or generative AI with emotion estimation functions. Generative AI may be, for example, text generation AI (such as LLM) or multimodal generative AI, but is not limited to such examples. Specifically, the installation unit inputs the user's face image (224×224 pixel RGB tensor), voice data (one-dimensional array sampled at 16 kHz), text input (ID sequence of up to 512 tokens), and behavioral log (structured data including location information and device operation history) to an emotion estimation AI model. The emotion estimation AI model is composed of a multimodal neural network integrating a CNN for image recognition, an RNN for voice feature extraction, and a Transformer for text analysis. The AI model outputs emotion labels such as “relaxed,” “stressed,” and “in a hurry” (in probability distribution format, e.g., relaxed 0.7, stressed 0.2, in a hurry 0.1) from the input data. The installation unit performs threshold judgment on this output and selects the optimal installation location from a candidate list (e.g., quiet location, lively location, near bus stop) according to the emotion with the highest probability. Furthermore, when selecting the installation location, the installation unit also inputs surrounding environment information (noise level sensor values, congestion camera images, weather sensor data, etc.) to the AI model and scores multiple installation candidates. For example, if the user is feeling stressed, the AI model outputs a high score for “quiet location,” and the installation unit issues a control signal to install digital signage at that location. The installation unit continuously monitors changes in user emotion and usage status after installation and automatically updates the installation optimization algorithm through online learning of the AI model. As a technical effect, the installation unit improves computer technology itself by realizing real-time and personalized installation optimization through integrated analysis of high-dimensional emotion, environment, and behavioral data, which is different from conventional experience-based or simple rule-based placement by humans, resulting in improved user experience, maximized information reach rate, reduced installation costs, and improved operational efficiency. Specific application fields include bus stops at tourist destinations, airports, train stations, shopping malls, hospitals, public facilities, and the advancement of digital signage installation optimization in all public spaces. Furthermore, variations of AI models include linkage of multiple models such as emotion estimation, behavior prediction, and environment recognition, cloud-edge cooperative processing, anonymization processing for privacy protection, and safety evaluation of installation locations through anomaly detection, enabling diverse embodiments.

The installation unit can select an appropriate installation position based on the surrounding environment or user flow lines. For example, the installation unit installs digital signage in locations with many bus stop users. The installation unit can install digital signage in highly visible locations by avoiding surrounding buildings and obstacles, for example. The installation unit can analyze user flow lines and install digital signage in locations where the most people pass, for example. As a result, the installation unit can select the optimal installation position by considering the surrounding environment and user flow lines. Specifically, the installation unit acquires data such as environmental sensors around bus stops (noise level sensors, illuminance sensors, temperature and humidity sensors), camera images (1920×1080 pixel RGB images), and user movement history data (time-series location vectors, e.g., latitude and longitude recorded every minute) as input. The installation unit inputs these data to environment recognition AI models and flow line analysis AI models. The environment recognition AI model uses CNNs for image recognition and object detection algorithms (YOLO, SSD, etc.) to extract the distribution of buildings, obstacles, and human flow. The flow line analysis AI model analyzes user movement history using time-series clustering (e.g., DBSCAN or LSTM-based time-series clustering) to identify main traffic routes and congestion points. Examples of AI model output include a scored list such as “installation candidate location A: visibility score 0.9, traffic volume score 0.8,” “installation candidate location B: visibility score 0.7, traffic volume score 0.95,” etc. The installation unit performs threshold judgment and weighted synthesis (e.g., visibility 0.6×traffic volume 0.4) on these scores for comprehensive evaluation and automatically selects the optimal installation position. Furthermore, the installation unit continuously collects camera images and sensor data after installation and dynamically updates the installation position optimization algorithm through online learning of the AI model. As a technical effect, the installation unit improves computer technology itself by realizing real-time and highly accurate installation optimization based on environment and flow line analysis, which is different from conventional placement relying on on-site surveys or experience by humans, resulting in improved information reach rate, reduced installation costs, improved operational efficiency, and improved user experience. Specific application fields include bus stops at tourist destinations, airports, train stations, shopping malls, hospitals, public facilities, and the advancement of digital signage installation optimization in all public spaces. Furthermore, variations of AI models include reallocation upon obstacle detection through anomaly detection, cloud-edge cooperative processing, and image anonymization processing for privacy protection, enabling diverse embodiments.

The installation unit can adjust surrounding lighting conditions to improve the visibility of the digital signage. For example, the installation unit installs lighting around the digital signage at night to improve visibility. The installation unit can adjust the installation position of the digital signage to avoid direct sunlight during the day, for example. The installation unit can use waterproof lighting to ensure visibility during rainy weather, for example. As a result, the installation unit improves the visibility of the digital signage by adjusting surrounding lighting conditions. Specifically, the installation unit acquires illuminance sensor data (e.g., analog values from 0 to 100,000 lux), weather sensor data (rain sensor, humidity sensor), and camera images (nighttime and daytime RGB images) in real time and uses a lighting control AI model as input. The lighting control AI model takes illuminance, weather, time of day, and human flow data as input and outputs optimal lighting patterns (e.g., LED lighting brightness level, on/off timing, waterproof lighting ON/OFF) and fine adjustment instructions for signage installation position. Examples of input to AI include “illuminance: 5,000 lux, weather: clear, time: 14:00,” “illuminance: 50 lux, weather: rain, time: 20:00,” etc. Examples of AI output include “lighting level: maximum, installation position: north-facing,” “lighting level: medium, waterproof lighting ON, installation position: shaded side,” etc. The installation unit automatically issues lighting control signals and installation position adjustment instructions based on AI output to always optimize signage visibility. Furthermore, the installation unit collects user visibility evaluations (questionnaires and gaze tracking data) and updates AI model parameters through online learning. As a technical effect, the installation unit improves computer technology itself by realizing real-time and environment-adaptive lighting and installation position optimization, which is different from conventional fixed lighting control or manual adjustment, resulting in improved visibility, reduced power consumption, reduced operational costs, and improved user experience. Specific application fields include bus stops at tourist destinations, airports, train stations, shopping malls, hospitals, public facilities, and the advancement of digital signage visibility optimization in all public spaces. Furthermore, variations of AI models include lighting failure detection through anomaly detection, cloud-edge cooperative processing, and image anonymization processing for privacy protection, enabling diverse embodiments.

The installation unit can estimate a user's emotion and adjust the installation height of the digital signage based on the estimated emotion of the user. For example, if the user is relaxed, the installation unit installs the digital signage at eye level. If the user is in a hurry, the installation unit can install the digital signage at a slightly higher position. If the user is feeling stressed, the installation unit can install the digital signage at a lower position. As a result, the installation unit improves user convenience by adjusting the installation height based on the user's emotion. Emotion estimation is realized using, for example, an emotion engine or generative AI with emotion estimation functions. Generative AI may be, for example, text generation AI (such as LLM) or multimodal generative AI, but is not limited to such examples. Specifically, the installation unit inputs the user's face image (224×224 pixel RGB tensor), voice data (one-dimensional array sampled at 16 kHz), text input (ID sequence of up to 512 tokens), and user height, age, and device information (smartphone, wheelchair use, etc.) to an emotion estimation AI model. The emotion estimation AI model is composed of a multimodal neural network integrating a CNN for image recognition, an RNN for voice feature extraction, and a Transformer for text analysis. The AI model outputs emotion labels such as “relaxed,” “stressed,” and “in a hurry” (in probability distribution format) from the input data, and the installation unit combines this output with user attribute information to select the optimal height from a candidate list (e.g., eye level 1.5 m, high 1.8 m, low 1.2 m). Examples of AI output include “emotion: relaxed 0.8→height 1.5 m,” “emotion: in a hurry 0.7→height 1.8 m,” “emotion: stressed 0.9→height 1.2 m,” etc. The installation unit collects user reactions (gaze tracking data, usage frequency, etc.) after installation and updates AI model parameters through online learning. As a technical effect, the installation unit improves computer technology itself by realizing real-time and personalized height optimization, which is different from conventional uniform height settings or manual adjustment, resulting in improved visibility and operability, universal design compatibility, improved user experience, and improved operational efficiency. Specific application fields include bus stops at tourist destinations, airports, train stations, shopping malls, hospitals, public facilities, and the advancement of digital signage installation height optimization in all public spaces. Furthermore, variations of AI models include linkage of multiple models such as emotion estimation, behavior prediction, and user attribute estimation, cloud-edge cooperative processing, and anonymization processing for privacy protection, enabling diverse embodiments.

The installation unit can adjust the installation angle of the digital signage to make information easier for users to view. For example, the installation unit installs the digital signage slightly upward to make it easier to see from a distance. The installation unit can install the digital signage slightly downward to make it easier to see from nearby, for example. The installation unit can install the digital signage horizontally to make it easy to see from any angle, for example. As a result, the installation unit makes information easier for users to view by adjusting the installation angle. Specifically, the installation unit inputs user gaze tracking data (gaze vectors extracted from camera images), device height and location information, and surrounding obstacle information (object detection results from image recognition AI) to an installation angle optimization AI model. The installation angle optimization AI model analyzes gaze distribution heatmaps and obstacle position vectors and outputs the optimal installation angle (e.g., upward 10 degrees, downward 5 degrees, horizontal 0 degrees). Examples of input to AI include “gaze distribution: concentrated at a distance, obstacles: none,” “gaze distribution: concentrated at close range, obstacles: 1 m ahead,” etc. Examples of AI output include “installation angle: upward 10 degrees,” “installation angle: downward 5 degrees,” “installation angle: horizontal 0 degrees,” etc. The installation unit issues control signals to the signage installation angle adjustment mechanism (motor control, etc.) based on AI output and optimizes the angle in real time. Furthermore, the installation unit collects user reactions (visibility evaluation, usage frequency, etc.) and updates AI model parameters through online learning. As a technical effect, the installation unit improves computer technology itself by realizing real-time and environment/user-adaptive angle optimization, which is different from conventional fixed angle installation or manual adjustment, resulting in improved visibility, maximized information reach rate, improved user experience, and improved operational efficiency. Specific application fields include bus stops at tourist destinations, airports, train stations, shopping malls, hospitals, public facilities, and the advancement of digital signage installation angle optimization in all public spaces. Furthermore, variations of AI models include re-adjustment upon obstacle detection through anomaly detection, cloud-edge cooperative processing, and image anonymization processing for privacy protection, enabling diverse embodiments.

The installation unit can install a security camera at the installation location of the digital signage to enhance security. For example, the installation unit installs security cameras around the digital signage to ensure user safety. The installation unit can monitor security camera footage in real time and issue warnings when abnormalities occur, for example. The installation unit can record security camera footage for later review, for example. As a result, the installation unit enhances security by installing security cameras. Specifically, the installation unit inputs video data from security cameras (1920×1080 pixel RGB video stream), voice data (sampled at 16 kHz), and environmental sensor data (vibration sensor, open/close sensor, etc.) to an anomaly detection AI model. The anomaly detection AI model is composed of a multimodal neural network combining a CNN for image recognition, an RNN for voice anomaly detection, and an LSTM for time-series analysis. The AI model outputs anomaly labels such as “no abnormality,” “suspicious person detected,” and “vandalism detected” (in probability distribution format) from the input data, and the installation unit performs threshold judgment on this output and issues a warning signal and notifies the management server or security guard terminal when an abnormality is detected. Examples of input to AI include “nighttime, person approaching signage, voice: loud,” “daytime, vibration sensor response, video: object thrown,” etc. Examples of AI output include “no abnormality,” “suspicious person detected: probability 0.85,” “vandalism detected: probability 0.92,” etc. The installation unit automatically saves video and voice data when abnormalities occur and uses them for later evidence confirmation and AI model retraining. As a technical effect, the installation unit improves computer technology itself by realizing real-time and highly accurate anomaly detection and automatic warning, which is different from conventional simple recording or manual monitoring, resulting in enhanced security, crime prevention, reduced operational costs, and improved user safety. Specific application fields include bus stops at tourist destinations, airports, train stations, shopping malls, hospitals, public facilities, and the advancement of security enhancement at digital signage installation locations in all public spaces. Furthermore, variations of AI models include linkage of multiple models such as anomaly detection, behavior prediction, and face recognition, cloud-edge cooperative processing, and anonymization processing for privacy protection, enabling diverse embodiments.

The provision unit can estimate a user's emotion and adjust the content of information provided based on the estimated emotion of the user. For example, if the user is relaxed, the provision unit provides tourist guidance. If the user is in a hurry, the provision unit can provide information about the nearest hospital or ATM. If the user is feeling stressed, the provision unit can guide the location of restrooms. As a result, the provision unit improves user convenience by adjusting the content of information based on the user's emotion. Emotion estimation is realized using, for example, an emotion engine or generative AI with emotion estimation functions. Generative AI may be, for example, text generation AI (such as LLM) or multimodal generative AI, but is not limited to such examples. Specifically, the provision unit inputs the user's face image (224×224 pixel RGB tensor), voice data (one-dimensional array sampled at 16 kHz), text input (ID sequence of up to 512 tokens), and behavioral log (structured data including location information and device operation history) to an emotion estimation AI model. The emotion estimation AI model is composed of a multimodal neural network integrating a CNN for image recognition, an RNN for voice feature extraction, and a Transformer for text analysis. The AI model outputs emotion labels such as “relaxed,” “stressed,” and “in a hurry” (in probability distribution format, e.g., relaxed 0.7, stressed 0.2, in a hurry 0.1) from the input data. For example, output examples include “relaxed 0.8, stressed 0.1, in a hurry 0.1” from face image and voice data, and “in a hurry 0.6, relaxed 0.3, stressed 0.1” from text input. The provision unit performs threshold judgment on this output and dynamically selects information content according to the emotion with the highest probability. For example, if “relaxed” is high, tourist guidance is provided; if “in a hurry” is high, hospital or ATM guidance is provided; if “stressed” is high, restroom guidance is prioritized. Furthermore, when generating information content, the provision unit utilizes large-scale language models and multimodal generative AI on the cloud, and generates multilingual and personalized guidance text, map images, and route guidance data (in JSON format) by considering the user's language settings and past usage history. Examples of AI output include “tourist guidance text (Japanese/English),” “department and consultation hours of the nearest hospital,” “map image for restroom guidance,” etc. These outputs are used for subsequent processing such as display on signage screens, push notifications to user devices, and voice synthesis for reading aloud. As a technical effect, the provision unit improves computer technology itself by realizing real-time and personalized information provision based on high-dimensional data analysis, which is different from conventional uniform information provision or manual guidance, resulting in improved user experience, faster information acquisition, reduced misguidance, and reduced operational costs. Specific application fields include bus stops at tourist destinations, airports, train stations, shopping malls, hospitals, public facilities, and the advancement of multilingual and emotion-adaptive guidance services in all public spaces. Furthermore, variations of AI models include linkage of multiple models such as emotion estimation, behavior prediction, and user attribute estimation, cloud-edge cooperative processing, anonymization processing for privacy protection, and elimination of inappropriate guidance through anomaly detection, enabling diverse embodiments.

The provision unit can provide appropriate information based on the user's past usage history. For example, the provision unit preferentially provides information about tourist spots the user has visited in the past. The provision unit can provide information about hospitals the user has used in the past, for example. The provision unit can provide information about ATMs the user has used in the past, for example. As a result, the provision unit can provide optimal information by referring to past usage history. Specifically, the provision unit manages a usage history database for each user recorded in chronological order (e.g., structured data including tourist spot ID, usage date and time, hospital ID, ATM usage history, search queries, device type, location information, etc.). When the user requests new information, the provision unit inputs past usage history to an AI model (for example, an RNN or Transformer-based history analysis model that takes user behavior sequences as input) and extracts history patterns and preferences. Examples of input to AI include “visited tourist spots A and B in the past week, used hospital X twice, used ATM Y once,” “used ATM five times and tourist spots twice in the past month,” etc. The AI model outputs scores such as “priority for tourist guidance 0.6, priority for hospital guidance 0.3, priority for ATM guidance 0.1” or “recommendation score for re-guidance to previously used facilities” from these history data. The provision unit generates and presents the most relevant information to the user (e.g., latest event information for previously visited tourist spots, updated consultation hours for used hospitals, extended available hours for ATM, etc.) based on this output. Furthermore, the provision unit implements anonymization processing and distributed database management for privacy protection of history data and thoroughly utilizes history based on user consent. Examples of AI output include “new event guidance for tourist spot A,” “information on department changes for hospital X,” “extended available hours for ATM Y,” etc. These outputs are used for subsequent processing such as display on signage screens, push notifications to user devices, and voice synthesis for guidance. As a technical effect, the provision unit improves computer technology itself by realizing high-dimensional history analysis and personalized information generation by AI, which is different from conventional static information provision or manual history reference, resulting in improved user experience, faster information acquisition, reduced misguidance, and reduced operational costs. Specific application fields include bus stops at tourist destinations, airports, train stations, shopping malls, hospitals, public facilities, and the advancement of history-linked guidance services in all public spaces. Furthermore, variations of AI models include linkage of multiple models such as behavior prediction, preference estimation, and anomaly detection, cloud-edge cooperative processing, and anonymization processing for privacy protection, enabling diverse embodiments.

The provision unit can preferentially provide information on the nearest facility based on the user's current location information. For example, the provision unit provides information about the nearest tourist spot from the user's current location. The provision unit can provide information about the nearest hospital from the user's current location, for example. The provision unit can provide information about the nearest ATM from the user's current location, for example. As a result, the provision unit can provide information on the nearest facility by considering current location information. Specifically, the provision unit receives current location information (GPS coordinates: numerical vectors of latitude and longitude, Wi-Fi triangulation results, beacon IDs, etc.) obtained from user devices or signage terminals in real time. The provision unit matches this location information with a facility database (storing coordinates and attribute information for tourist spots, hospitals, ATMs, restrooms, etc.), and uses distance calculation algorithms (e.g., Haversine distance, Euclidean distance) or route search algorithms (e.g., A*, Dijkstra's algorithm) to identify the nearest facility. AI models (for example, ranking models that take location information and facility attributes as input, or recommendation models that consider user movement history) output scored lists such as “tourist spot A is 100 m away,” “hospital X is 200 m away,” “ATM Y is 50 m away” from the input data. Examples of input to AI include “current location: latitude 35.1234, longitude 139.5678,” “current location: north side of bus stop, movement direction: south,” etc. Examples of AI output include “nearest ATM: 50 m ahead on the right,” “nearest hospital: 200 m ahead on the left,” “tourist spot A: 3 minutes on foot,” etc. The provision unit uses these outputs for subsequent processing such as map display on signage screens, route guidance push notifications to user devices, and voice synthesis for reading aloud. Furthermore, the provision unit can also consider user movement speed and congestion status to propose optimal guidance timing and route changes. As a technical effect, the provision unit improves computer technology itself by realizing real-time and highly accurate location information analysis and optimal facility recommendation, which is different from conventional static facility guidance or manual map guidance, resulting in improved user experience, faster information acquisition, reduced misguidance, and reduced operational costs. Specific application fields include bus stops at tourist destinations, airports, train stations, shopping malls, hospitals, public facilities, and the advancement of location-linked guidance services in all public spaces. Furthermore, variations of AI models include avoidance of facility congestion through anomaly detection, cloud-edge cooperative processing, and anonymization processing for privacy protection, enabling diverse embodiments.

The provision unit can estimate a user's emotion and adjust the display method of information provided based on the estimated emotion of the user. For example, if the user is relaxed, the provision unit displays detailed information. If the user is in a hurry, the provision unit can display concise information focusing on key points. If the user is feeling stressed, the provision unit can display simple information. As a result, the provision unit improves user convenience by adjusting the display method based on the user's emotion. Emotion estimation is realized using, for example, an emotion engine or generative AI with emotion estimation functions. Generative AI may be, for example, text generation AI (such as LLM) or multimodal generative AI, but is not limited to such examples. Specifically, the provision unit inputs the user's face image (224×224 pixel RGB tensor), voice data (one-dimensional array sampled at 16 kHz), text input (ID sequence of up to 512 tokens), and behavioral log (structured data including device operation history and location information) to an emotion estimation AI model. The emotion estimation AI model is composed of a multimodal neural network integrating a CNN for image recognition, an RNN for voice feature extraction, and a Transformer for text analysis. The AI model outputs emotion labels such as “relaxed,” “stressed,” and “in a hurry” (in probability distribution format) from the input data. For example, output examples include “relaxed 0.8, stressed 0.1, in a hurry 0.1” or “in a hurry 0.7, relaxed 0.2, stressed 0.1.” The provision unit performs threshold judgment on this output and dynamically selects the display method according to the emotion with the highest probability. For example, if “relaxed” is high, detailed information (e.g., history of tourist spots and information about surrounding facilities) is displayed; if “in a hurry” is high, only key points (e.g., facility name, distance, business hours) are displayed; if “stressed” is high, simple guidance (e.g., only the location of restrooms) is displayed. Furthermore, the provision unit utilizes large-scale language models and multimodal generative AI on the cloud and automatically switches the display format (text, image, voice) according to the user's language settings and device type. Examples of AI output include “detailed guidance text,” “bullet points of key points only,” “simple map image,” etc. These outputs are used for subsequent processing such as display on signage screens, push notifications to user devices, and voice synthesis for reading aloud. As a technical effect, the provision unit improves computer technology itself by realizing real-time and emotion-adaptive display optimization, which is different from conventional uniform display or manual guidance, resulting in improved user experience, faster information acquisition, reduced misguidance, and reduced operational costs. Specific application fields include bus stops at tourist destinations, airports, train stations, shopping malls, hospitals, public facilities, and the advancement of emotion-adaptive guidance services in all public spaces. Furthermore, variations of AI models include linkage of multiple models such as emotion estimation, behavior prediction, and user attribute estimation, cloud-edge cooperative processing, and anonymization processing for privacy protection, enabling diverse embodiments.

The provision unit can automatically switch the display language of information based on the user's language settings. For example, the provision unit automatically switches the display language of information based on the language settings of the user's device. The provision unit can provide a language switching function when the user uses multiple languages, for example. The provision unit can display information in the selected language when the user selects a specific language, for example. As a result, the provision unit improves user convenience by switching the display language based on language settings. Specifically, the provision unit inputs language setting information obtained from user devices or signage terminals (e.g., OS language code, browser Accept-Language header, user-selected language ID, etc.) and uses large-scale multilingual language models or neural machine translation models (for example, Transformer-based multilingual models) on the cloud to automatically translate and generate guidance text, map images, and route guidance data into the specified language. Examples of input to AI include “display language: Japanese,” “display language: English,” “display language: Simplified Chinese,” etc. Examples of AI output include “tourist guidance text (Japanese),” “ATM guidance text (English),” “hospital guidance text (Chinese),” etc. The provision unit automatically displays these outputs on signage screens and user devices, and provides language switching buttons and multilingual selection menus on the user interface. Furthermore, when the user uses multiple languages, the provision unit analyzes past language usage history and device settings with AI models and can estimate and propose the optimal display language. As a technical effect, the provision unit improves computer technology itself by realizing real-time and automatic multilingual switching and translation, which is different from conventional fixed language display or manual translation, resulting in improved user experience, faster information acquisition, reduced misguidance, and reduced operational costs. Specific application fields include bus stops at tourist destinations, airports, train stations, shopping malls, hospitals, public facilities, and the advancement of multilingual guidance services in all public spaces. Furthermore, variations of AI models include linkage of multiple models such as voice recognition, translation, and emotion estimation, cloud-edge cooperative processing, and anonymization processing for privacy protection, enabling diverse embodiments.

The provision unit can push information notifications to a smartphone based on the user's device information. For example, when the user is using a smartphone, the provision unit pushes information notifications to the smartphone. When the user is using a tablet, the provision unit can push information notifications to the tablet, for example. When the user is using a smartwatch, the provision unit can push information notifications to the smartwatch, for example. As a result, the provision unit can appropriately push information notifications by considering device information. Specifically, the provision unit inputs device information obtained from user devices (device type: smartphone, tablet, smartwatch, OS type, screen size, notification permission settings, etc. as structured data) to a push notification control AI model (for example, a rule-based model or reinforcement learning model that takes device attributes and usage status as input) and determines the optimal notification timing, notification content, and notification format (text, image, voice, link, etc.). Examples of input to AI include “device type: smartphone, notification permission ON,” “device type: tablet, screen size 10 inches,” “device type: smartwatch, notification permission ON,” etc. Examples of AI output include “notify tourist guidance text to smartphone,” “notify map image to tablet,” “notify only key points to smartwatch,” etc. The provision unit pushes information to each device via the OS or application notification API based on these outputs. Furthermore, the provision unit collects user notification responses (open rate, click rate, notification rejection rate, etc.) in real time and optimizes AI model parameters through online learning. As a technical effect, the provision unit improves computer technology itself by realizing real-time and device-adaptive notification optimization, which is different from conventional uniform notification or manual distribution, resulting in improved information reach rate, improved user experience, maximized notification effectiveness, and reduced operational costs. Specific application fields include bus stops at tourist destinations, airports, train stations, shopping malls, hospitals, public facilities, and the advancement of multi-device information notification services in all public spaces. Furthermore, variations of AI models include linkage of multiple models such as behavior prediction, emotion estimation, and device attribute estimation, cloud-edge cooperative processing, and anonymization processing for privacy protection, enabling diverse embodiments.

The wireless LAN unit is capable of estimating a user's emotion and adjusting the connection speed of the wireless LAN based on the estimated emotion of the user. For example, the wireless LAN unit provides a normal connection speed when the user is relaxed. The wireless LAN unit can provide a high-speed connection when the user is in a hurry. The wireless LAN unit can provide a stable connection speed when the user is feeling stressed. By adjusting the connection speed based on the user's emotion, the wireless LAN unit improves user convenience. Emotion estimation is realized using an emotion estimation function, for example, by employing an emotion engine or generative AI. Generative AI may include, for example, text generation AI (such as LLM) or multimodal generative AI, but is not limited thereto. Specifically, the wireless LAN unit inputs facial images (224×224 pixel RGB tensor), voice data (16 kHz sampling, one-dimensional array), text input (ID sequence of up to 512 tokens), and behavioral logs including terminal operation history and location information (structured data) obtained from the user terminal into an emotion estimation AI model. The emotion estimation AI model is configured as a multimodal neural network integrating a CNN for image recognition, an RNN for voice feature extraction, and a Transformer for text analysis. The AI model outputs emotion labels such as “relaxed,” “stressed,” and “in a hurry” in the form of probability distributions (e.g., relaxed 0.6, in a hurry 0.3, stressed 0.1) based on the input data. For example, outputs such as “relaxed 0.7, in a hurry 0.2, stressed 0.1” from facial images and voice data, and “in a hurry 0.8, relaxed 0.1, stressed 0.1” from text input are possible. The wireless LAN unit performs threshold judgment on these output results and inputs the emotion with the highest probability into a connection speed control AI model. The connection speed control AI model takes as input the user's emotion label, terminal type, current communication load, application type (video streaming, web browsing, etc.), battery level, and outputs the optimal connection speed (e.g., 20 Mbps, 50 Mbps, 100 Mbps) and QoS parameters (latency tolerance, packet loss tolerance, etc.). Examples of AI input include “emotion: in a hurry 0.8, device: smartphone, app: video streaming” and “emotion: stressed 0.9, device: tablet, app: web browsing.” Examples of AI output include “connection speed: 100 Mbps, latency tolerance: 30 ms” and “connection speed: 20 Mbps, stability prioritized.” The wireless LAN unit automatically issues bandwidth allocation and QoS control signals to access points based on the AI output, optimizing the connection speed to user terminals in real time. Furthermore, the wireless LAN unit continuously collects user communication quality evaluations (throughput, disconnection rate, reconnection count, etc.) and updates AI model parameters through online learning. As a technical effect, the wireless LAN unit, unlike conventional uniform speed settings or manual bandwidth adjustments, realizes real-time, emotion-adaptive connection speed optimization, thereby improving communication quality, enhancing user experience, efficiently utilizing bandwidth resources, and reducing operational costs, resulting in improvements to computer technology itself. Specific application fields include emotion-adaptive wireless communication services in public spaces such as bus stops at tourist sites, airports, train stations, shopping malls, hospitals, and public facilities. Additionally, variations of the AI model may include automatic reconfiguration during communication failures via anomaly detection, cloud-edge cooperative processing, anonymization for privacy protection, and fairness optimization among multiple users, enabling diverse embodiments.

The wireless LAN unit is capable of performing appropriate connection settings according to the type of user's device. For example, when a smartphone is used, the wireless LAN unit performs connection settings optimized for the smartphone. When a tablet is used, the wireless LAN unit can perform connection settings optimized for the tablet. When a laptop is used, the wireless LAN unit can perform connection settings optimized for the laptop. By performing optimal connection settings according to the device type, the wireless LAN unit improves connection convenience. Specifically, the wireless LAN unit inputs device information obtained from the user terminal (structured data including device type: smartphone, tablet, laptop, OS type, screen size, wireless standard compatibility, battery level, etc.) into a connection setting optimization AI model (for example, a rule-based model or reinforcement learning model that takes device attributes and usage status as input) to determine optimal connection settings (e.g., bandwidth allocation, channel selection, transmission power, QoS parameters, security protocol selection, etc.). Examples of AI input include “device type: smartphone, OS: Android, screen size 6 inches,” “device type: tablet, OS: iOS, screen size 10 inches,” and “device type: laptop, OS: Windows, Wi-Fi 6 compatible.” Examples of AI output include “bandwidth: 20 Mbps, channel: 36, QoS: standard,” “bandwidth: 50 Mbps, channel: 44, QoS: high,” and “bandwidth: 100 Mbps, channel: 149, QoS: highest.” The wireless LAN unit automatically changes access point setting parameters based on the AI output and provides the optimal connection environment to each terminal in real time. Furthermore, the wireless LAN unit continuously monitors communication quality for each terminal (throughput, latency, packet loss, etc.) and application type (video, web, game, etc.), and optimizes AI model parameters through online learning. As a technical effect, the wireless LAN unit, unlike conventional uniform settings or manual device configuration, realizes real-time, device-adaptive connection optimization, thereby improving communication quality, enhancing user experience, efficiently utilizing bandwidth resources, and reducing operational costs, resulting in improvements to computer technology itself. Specific application fields include advanced multi-device wireless communication services in public spaces such as bus stops at tourist sites, airports, train stations, shopping malls, hospitals, and public facilities. Additionally, variations of the AI model may include automatic reconfiguration during device failures via anomaly detection, cloud-edge cooperative processing, and anonymization for privacy protection, enabling diverse embodiments.

The wireless LAN unit is capable of referring to the user's connection history to determine the priority of connection. For example, the wireless LAN unit prioritizes connection for users who have frequently connected in the past. The wireless LAN unit can prioritize connection for users whose past connections were unstable. The wireless LAN unit can prioritize connection for users whose past connections were stable. By referring to connection history, the wireless LAN unit can appropriately determine connection priority. Specifically, the wireless LAN unit manages a connection history database for each user, recorded in chronological order (structured data including connection date and time, connection duration, number of disconnections, communication quality indicators, device type, application usage, etc.). When a user issues a new connection request, the wireless LAN unit inputs past connection history into an AI model (for example, a history analysis model based on RNN or Transformer that takes user connection sequences as input) to calculate connection stability and priority scores. Examples of AI input include “5 connections in the past week, 1 disconnection, average communication speed 20 Mbps” and “10 connections in the past month, 0 disconnections, average latency 30 ms.” The AI model outputs scores such as “priority score 0.9,” “stability score 0.8,” and “reconnection recommendation score 0.7” based on these history data. The wireless LAN unit, based on these output results, grants connection permission and allocates bandwidth in order of highest priority when there are many simultaneous users. Furthermore, to protect the privacy of connection history, the wireless LAN unit implements anonymization and distributed database management, thoroughly utilizing history based on user consent. Examples of AI output include “priority connection permission,” “reconnection recommendation,” and “bandwidth increase.” These outputs are used for subsequent processing such as access point control signals and connection notifications to user terminals. As a technical effect, the wireless LAN unit, unlike conventional uniform connections or manual history reference, realizes high-dimensional history analysis and priority optimization by AI, thereby improving communication quality, reducing disconnection rates, enhancing user experience, and reducing operational costs, resulting in improvements to computer technology itself. Specific application fields include advanced history-linked wireless communication services in public spaces such as bus stops at tourist sites, airports, train stations, shopping malls, hospitals, and public facilities. Additionally, variations of the AI model may include cooperation among multiple models for behavior prediction, anomaly detection, device attribute estimation, cloud-edge cooperative processing, and anonymization for privacy protection, enabling diverse embodiments.

The wireless LAN unit is capable of estimating a user's emotion and adjusting the connection time of the wireless LAN based on the estimated emotion of the user. For example, the wireless LAN unit provides a normal connection time when the user is relaxed. The wireless LAN unit can disconnect the connection in a short time when the user is in a hurry. The wireless LAN unit can provide a long connection time when the user is feeling stressed. By adjusting the connection time based on the user's emotion, the wireless LAN unit improves user convenience. Emotion estimation is realized using an emotion estimation function, for example, by employing an emotion engine or generative AI. Generative AI may include, for example, text generation AI (such as LLM) or multimodal generative AI, but is not limited thereto. Specifically, the wireless LAN unit inputs facial images (224×224 pixel RGB tensor), voice data (16 kHz sampling, one-dimensional array), text input (ID sequence of up to 512 tokens), and behavioral logs including terminal operation history and location information (structured data) obtained from the user terminal into an emotion estimation AI model. The emotion estimation AI model is configured as a multimodal neural network integrating a CNN for image recognition, an RNN for voice feature extraction, and a Transformer for text analysis. The AI model outputs emotion labels such as “relaxed,” “stressed,” and “in a hurry” in the form of probability distributions (e.g., relaxed 0.5, in a hurry 0.4, stressed 0.1) based on the input data. For example, outputs such as “relaxed 0.6, in a hurry 0.3, stressed 0.1” from facial images and voice data, and “in a hurry 0.7, relaxed 0.2, stressed 0.1” from text input are possible. The wireless LAN unit performs threshold judgment on these output results and inputs the emotion with the highest probability into a connection time control AI model. The connection time control AI model takes as input the user's emotion label, terminal type, application type, battery level, current communication load, and outputs the optimal connection time (e.g., normal 30 minutes, shortened 10 minutes, extended 60 minutes) and automatic disconnection timing. Examples of AI input include “emotion: in a hurry 0.8, device: smartphone, app: web browsing” and “emotion: stressed 0.9, device: tablet, app: video viewing.” Examples of AI output include “connection time: 10 minutes,” “connection time: 60 minutes,” and “automatic disconnection: enabled.” The wireless LAN unit automatically issues connection management signals to access points based on the AI output, optimizing the connection time to user terminals in real time. Furthermore, the wireless LAN unit continuously collects user communication quality evaluations and usage status, and updates AI model parameters through online learning. As a technical effect, the wireless LAN unit, unlike conventional uniform connection time settings or manual management, realizes real-time, emotion-adaptive connection time optimization, thereby improving communication quality, enhancing user experience, efficiently utilizing bandwidth resources, and reducing operational costs, resulting in improvements to computer technology itself. Specific application fields include emotion-adaptive wireless communication services in public spaces such as bus stops at tourist sites, airports, train stations, shopping malls, hospitals, and public facilities. Additionally, variations of the AI model may include automatic disconnection during unauthorized use via anomaly detection, cloud-edge cooperative processing, and anonymization for privacy protection, enabling diverse embodiments.

The wireless LAN unit is capable of selecting an appropriate access point based on the user's location information. For example, the wireless LAN unit selects the access point closest to the user's current location. The wireless LAN unit can select the optimal access point by considering the user's movement route. The wireless LAN unit can update the user's location information in real time and select the optimal access point. By considering location information, the wireless LAN unit can select the optimal access point. Specifically, the wireless LAN unit receives current location information (GPS coordinates: latitude and longitude numerical vectors, Wi-Fi triangulation results, beacon IDs, etc.) obtained from user terminals or signage terminals in real time. The wireless LAN unit compares this location information with an access point placement database (storing coordinates, output range, congestion level, etc. for each AP), and uses distance calculation algorithms (e.g., Euclidean distance, Haversine distance) or route prediction algorithms (e.g., LSTM-based movement route prediction models) to identify the optimal access point. The AI model (for example, a ranking model that takes location information and AP attributes as input, or a recommendation model that considers user movement history) outputs a scored list such as “AP 1: 30 m away, low congestion” and “AP 2: 50 m away, high congestion” based on the input data. Examples of AI input include “current location: latitude 35.1234, longitude 139.5678” and “movement direction: south, speed: 3 km/h.” Examples of AI output include “optimal AP: AP1, distance 30 m” and “optimal AP: AP2, low congestion.” The wireless LAN unit issues access point connection control signals based on these outputs, automatically switching and optimizing the connection destination AP for user terminals. Furthermore, the wireless LAN unit considers user movement speed and congestion status, and optimizes handover and load balancing using AI. As a technical effect, the wireless LAN unit, unlike conventional fixed AP selection or manual connection destination specification, realizes real-time, high-precision location information analysis and optimal AP selection, thereby improving communication quality, reducing disconnection rates, enhancing user experience, and reducing operational costs, resulting in improvements to computer technology itself. Specific application fields include advanced location-linked wireless communication services in public spaces such as bus stops at tourist sites, airports, train stations, shopping malls, hospitals, and public facilities. Additionally, variations of the AI model may include automatic reselection during AP failures via anomaly detection, cloud-edge cooperative processing, and anonymization for privacy protection, enabling diverse embodiments.

The wireless LAN unit is capable of determining the priority of connection based on the battery level of the user's device. For example, the wireless LAN unit prioritizes connection for users with low battery levels. The wireless LAN unit can delay connection for users with high battery levels. The wireless LAN unit can extend the connection time for users whose battery level is below a certain threshold. By considering battery level, the wireless LAN unit can appropriately determine connection priority. Specifically, the wireless LAN unit inputs battery level information obtained from the user terminal (structured data including percentage value, device type, charging status, etc.) into a connection priority optimization AI model (for example, a rule-based model or reinforcement learning model that takes battery level and usage status as input) to determine optimal connection priority (e.g., high, medium, low) and connection time extension instructions. Examples of AI input include “device type: smartphone, battery level 15%” and “device type: tablet, battery level 80%.” Examples of AI output include “priority: high, connection time extension” and “priority: low, normal connection.” The wireless LAN unit automatically issues connection management signals to access points based on the AI output, realizing real-time connection prioritization and connection time extension for users with low battery levels. Furthermore, the wireless LAN unit continuously monitors battery consumption trends and application types used by users, and optimizes AI model parameters through online learning. As a technical effect, the wireless LAN unit, unlike conventional uniform connections or manual priority settings, realizes real-time, battery-adaptive connection optimization, thereby improving user experience, communication quality, battery consumption optimization, and reducing operational costs, resulting in improvements to computer technology itself. Specific application fields include advanced battery-linked wireless communication services in public spaces such as bus stops at tourist sites, airports, train stations, shopping malls, hospitals, and public facilities. Additionally, variations of the AI model may include automatic warnings during battery anomalies via anomaly detection, cloud-edge cooperative processing, and anonymization for privacy protection, enabling diverse embodiments.

The advertisement unit is capable of estimating a user's emotion and adjusting the content of advertisements based on the estimated emotion of the user. For example, when the user is relaxed, the advertisement unit displays advertisements for products or services that promote relaxation. When the user is in a hurry, the advertisement unit can display advertisements for products or services that can be used quickly. When the user is feeling stressed, the advertisement unit can display advertisements for products or services that help relieve stress. By adjusting advertisement content based on the user's emotion, the advertisement unit enhances the effectiveness of advertisements. Emotion estimation is realized using an emotion estimation function, for example, by employing an emotion engine or generative AI. Generative AI may include, for example, text generation AI (such as LLM) or multimodal generative AI, but is not limited thereto. Specifically, the advertisement unit inputs facial images (224×224 pixel RGB tensor), voice data (16 kHz sampling, one-dimensional array), text input (ID sequence of up to 512 tokens), and user behavioral logs (location information, terminal operation history, past advertisement viewing history, purchase history, etc., structured data) obtained from user terminals or signage terminals into an emotion estimation AI model. The emotion estimation AI model is configured as a multimodal neural network integrating a convolutional neural network (CNN) for image recognition, a recurrent neural network (RNN) for voice feature extraction, and a Transformer for text analysis. The AI model outputs emotion labels such as “relaxed,” “stressed,” and “in a hurry” in the form of probability distributions (e.g., relaxed 0.7, stressed 0.2, in a hurry 0.1) based on the input data. For example, outputs such as “relaxed 0.8, stressed 0.1, in a hurry 0.1” from facial images and voice data, and “in a hurry 0.6, relaxed 0.3, stressed 0.1” from text input are possible. The advertisement unit performs threshold judgment on these output results and inputs the emotion with the highest probability into an advertisement content generation AI model. The advertisement content generation AI model takes as input emotion labels, user attribute information (age group, gender, current location, device type, etc.), past advertisement viewing and purchase history, current time zone, and weather information, and generates/selects optimal advertisement content (e.g., cafe advertisement video for relaxation, takeout service banner for users in a hurry, coupon for stress relief goods, etc.). Examples of AI input include “emotion: relaxed 0.8, age group: female in her 30s, current location: in front of the station” and “emotion: in a hurry 0.7, device: smartphone, clicked on transportation-related ads three times in the past.” Examples of AI output include “video URL for cafe advertisement for relaxation,” “banner image for takeout service for users in a hurry,” and “discount coupon for stress relief goods.” The advertisement unit executes subsequent processing such as displaying advertisements on signage screens, push notifications to user terminals, and optimizing advertisement display frequency and timing based on these outputs. Furthermore, the advertisement unit collects advertisement click rates and user reactions (dwell time, purchase rate, etc.) in real time and optimizes AI model parameters through online learning. As a technical effect, the advertisement unit, unlike conventional uniform distribution-type advertisements or manual advertisement selection, realizes real-time, personalized advertisement generation and distribution based on high-dimensional data analysis, thereby maximizing advertisement effectiveness, enhancing user experience, increasing advertising revenue, and reducing operational costs, resulting in improvements to computer technology itself. Specific application fields include advanced emotion-adaptive advertisement distribution services in public spaces such as bus stops at tourist sites, airports, train stations, shopping malls, hospitals, and public facilities. Additionally, variations of the AI model may include cooperation among multiple models for emotion estimation, behavior prediction, user attribute estimation, image recognition, anomaly detection, cloud-edge cooperative processing, anonymization for privacy protection, and inappropriate advertisement exclusion, enabling diverse embodiments.

The advertisement unit is capable of referring to the user's past advertisement viewing history to distribute optimal advertisements. For example, the advertisement unit distributes advertisements for products or services related to advertisements previously viewed by the user. The advertisement unit can distribute advertisements for products or services related to advertisements previously clicked by the user. The advertisement unit can distribute advertisements related to products or services previously purchased by the user. By referring to past advertisement viewing history, the advertisement unit can distribute optimal advertisements. Specifically, the advertisement unit manages an advertisement viewing history database for each user, recorded in chronological order (structured data including advertisement ID, viewing date and time, click history, purchase history, device type, location information, etc.). When a user newly views an advertisement or requests information, the advertisement unit inputs past advertisement viewing, click, and purchase history into an AI model (for example, a history analysis model based on recurrent neural networks or Transformer that takes user behavior sequences as input) to extract history patterns and preferences. Examples of AI input include “viewed cafe advertisements three times, clicked twice, purchased once in the past week” and “viewed travel-related advertisements five times, clicked zero times in the past month.” The AI model outputs scores such as “cafe advertisement recommendation score 0.7, travel advertisement recommendation score 0.2, home appliance advertisement recommendation score 0.1” and “re-presentation recommendation score for previously used products” based on these history data. The advertisement unit, based on these output results, preferentially generates and presents advertisements most relevant to the user (e.g., new menu advertisement for a previously visited cafe, related service advertisement for a purchased product, latest information for a clicked event). Furthermore, to protect the privacy of history data, the advertisement unit implements anonymization and distributed database management, thoroughly utilizing history based on user consent. Examples of AI output include “video advertisement for new cafe menu,” “banner for related services of purchased products,” and “interactive advertisement for latest event information.” These outputs are used for subsequent processing such as displaying advertisements on signage screens, push notifications to user terminals, and optimizing advertisement display frequency and timing. As a technical effect, the advertisement unit, unlike conventional static advertisement distribution or manual history reference, realizes high-dimensional history analysis and personalized advertisement generation by AI, thereby maximizing advertisement effectiveness, enhancing user experience, increasing advertising revenue, and reducing operational costs, resulting in improvements to computer technology itself. Specific application fields include advanced history-linked advertisement distribution services in public spaces such as bus stops at tourist sites, airports, train stations, shopping malls, hospitals, and public facilities. Additionally, variations of the AI model may include cooperation among multiple models for behavior prediction, preference estimation, anomaly detection, user attribute estimation, cloud-edge cooperative processing, and anonymization for privacy protection, enabling diverse embodiments.

The advertisement unit is capable of distributing region-specific advertisements by considering the user's current location information. For example, the advertisement unit distributes advertisements for stores near the user's current location. The advertisement unit can distribute advertisements for events related to the user's current location. The advertisement unit can distribute region-limited coupons based on the user's current location. By considering location information, the advertisement unit can distribute region-specific advertisements. Specifically, the advertisement unit receives current location information (GPS coordinates: latitude and longitude numerical vectors, Wi-Fi triangulation results, beacon IDs, etc.) obtained from user terminals or signage terminals in real time. The advertisement unit compares this location information with a regional facility database for stores, events, coupons, etc. (storing coordinates, attributes, advertisement inventory information for each facility), and uses distance calculation algorithms (e.g., Euclidean distance, Haversine distance) or route search algorithms (e.g., A*, Dijkstra's algorithm) to identify the nearest facility. The AI model (for example, a ranking model that takes location information and facility attributes as input, or a recommendation model that considers user movement history) outputs a scored list such as “Store A: 50 m away, Event B: 100 m away, Coupon C: within valid range” based on the input data. Examples of AI input include “current location: latitude 35.1234, longitude 139.5678” and “current location: south side of bus stop, movement direction: east.” Examples of AI output include “discount coupon for nearest cafe,” “banner advertisement for event in front of the station,” and “video advertisement for region-limited shop.” The advertisement unit executes subsequent processing such as displaying advertisements on signage screens, push notifications to user terminals, and optimizing advertisement display frequency and timing based on these outputs. Furthermore, the advertisement unit considers user movement speed and congestion status to propose optimal advertisement distribution timing and route changes. As a technical effect, the advertisement unit, unlike conventional static advertisement distribution or manual map guidance, realizes real-time, high-precision location information analysis and region-specific advertisement recommendation, thereby maximizing advertisement effectiveness, enhancing user experience, increasing advertising revenue, and reducing operational costs, resulting in improvements to computer technology itself. Specific application fields include advanced location-linked advertisement distribution services in public spaces such as bus stops at tourist sites, airports, train stations, shopping malls, hospitals, and public facilities. Additionally, variations of the AI model may include congestion avoidance advertisement distribution via anomaly detection, cloud-edge cooperative processing, and anonymization for privacy protection, enabling diverse embodiments.

The advertisement unit is capable of estimating a user's emotion and adjusting the display frequency of advertisements based on the estimated emotion of the user. For example, when the user is relaxed, the advertisement unit sets the display frequency of advertisements to normal. When the user is in a hurry, the advertisement unit can set the display frequency of advertisements to low. When the user is feeling stressed, the advertisement unit can set the display frequency of advertisements to low. By adjusting the display frequency of advertisements based on the user's emotion, the advertisement unit enhances the effectiveness of advertisements. Emotion estimation is realized using an emotion estimation function, for example, by employing an emotion engine or generative AI. Generative AI may include, for example, text generation AI (such as LLM) or multimodal generative AI, but is not limited thereto. Specifically, the advertisement unit inputs facial images (224×224 pixel RGB tensor), voice data (16 kHz sampling, one-dimensional array), text input (ID sequence of up to 512 tokens), and user behavioral logs (location information, terminal operation history, past advertisement viewing history, etc., structured data) obtained from user terminals or signage terminals into an emotion estimation AI model. The emotion estimation AI model is configured as a multimodal neural network integrating a CNN for image recognition, an RNN for voice feature extraction, and a Transformer for text analysis. The AI model outputs emotion labels such as “relaxed,” “stressed,” and “in a hurry” in the form of probability distributions (e.g., relaxed 0.6, in a hurry 0.3, stressed 0.1) based on the input data. For example, outputs such as “relaxed 0.7, in a hurry 0.2, stressed 0.1” from facial images and voice data, and “in a hurry 0.8, relaxed 0.1, stressed 0.1” from text input are possible. The advertisement unit performs threshold judgment on these output results and inputs the emotion with the highest probability into an advertisement display frequency control AI model. The advertisement display frequency control AI model takes as input emotion labels, user attribute information, past advertisement reaction history, current time zone, and congestion status, and outputs optimal advertisement display frequency (e.g., normal, low frequency, high frequency) and display interval. Examples of AI input include “emotion: relaxed 0.8, high past advertisement click rate” and “emotion: in a hurry 0.7, no advertisement reaction.” Examples of AI output include “display frequency: normal,” “display frequency: low,” and “display interval: 10 minutes.” The advertisement unit optimizes the advertisement display frequency on signage screens and user terminals in real time based on the AI output. Furthermore, the advertisement unit continuously collects user advertisement reactions (click rate, dwell time, etc.) and updates AI model parameters through online learning. As a technical effect, the advertisement unit, unlike conventional uniform display frequency or manual adjustment, realizes real-time, emotion-adaptive advertisement display frequency optimization, thereby maximizing advertisement effectiveness, enhancing user experience, increasing advertising revenue, and reducing operational costs, resulting in improvements to computer technology itself. Specific application fields include advanced emotion-adaptive advertisement distribution services in public spaces such as bus stops at tourist sites, airports, train stations, shopping malls, hospitals, and public facilities. Additionally, variations of the AI model may include cooperation among multiple models for emotion estimation, behavior prediction, user attribute estimation, anomaly detection, cloud-edge cooperative processing, and anonymization for privacy protection, enabling diverse embodiments.

The advertisement unit is capable of pushing advertisements to smartphones based on the user's device information. For example, when the user is using a smartphone, the advertisement unit pushes advertisements to the smartphone. When the user is using a tablet, the advertisement unit can push advertisements to the tablet. When the user is using a smartwatch, the advertisement unit can push advertisements to the smartwatch. By considering device information, the advertisement unit can appropriately push advertisements. Specifically, the advertisement unit inputs device information obtained from the user terminal (structured data including device type: smartphone, tablet, smartwatch, OS type, screen size, notification permission settings, etc.) into a push notification control AI model (for example, a rule-based model or reinforcement learning model that takes device attributes and usage status as input) to determine optimal notification timing, notification content, and notification format (text, image, voice, link, etc.). Examples of AI input include “device type: smartphone, notification permission ON,” “device type: tablet, screen size 10 inches,” and “device type: smartwatch, notification permission ON.” Examples of AI output include “notify cafe advertisement text to smartphone,” “notify event banner image to tablet,” and “notify summary advertisement to smartwatch.” The advertisement unit pushes advertisements via the OS or application notification API of each terminal based on these outputs. Furthermore, the advertisement unit collects user notification reactions (open rate, click rate, notification rejection rate, etc.) in real time and optimizes AI model parameters through online learning. As a technical effect, the advertisement unit, unlike conventional uniform notifications or manual distribution, realizes real-time, device-adaptive advertisement notification optimization, thereby improving advertisement reach rate, enhancing user experience, maximizing advertisement effectiveness, and reducing operational costs, resulting in improvements to computer technology itself. Specific application fields include advanced multi-device advertisement notification services in public spaces such as bus stops at tourist sites, airports, train stations, shopping malls, hospitals, and public facilities. Additionally, variations of the AI model may include cooperation among multiple models for behavior prediction, emotion estimation, device attribute estimation, cloud-edge cooperative processing, and anonymization for privacy protection, enabling diverse embodiments.

The advertisement unit is capable of analyzing the user's social media activity to distribute relevant advertisements. For example, the advertisement unit distributes advertisements for products or services that the user has liked on social media. The advertisement unit can distribute advertisements for brands followed by the user on social media. The advertisement unit can distribute advertisements related to events shared by the user on social media. By analyzing social media activity, the advertisement unit can distribute relevant advertisements. Specifically, the advertisement unit obtains user social media activity data (structured data including post text, images, videos, like history, follow relationships, share history, comment history, etc.) via APIs and the like. The advertisement unit inputs these data into large language models for natural language processing, image recognition AI models, and behavior analysis AI models (for example, Transformer-based text analysis models, CNN-based image recognition models, RNN-based behavior sequence analysis models) to extract user interests, brand preferences, and event participation tendencies. Examples of AI input include “liked cafe-related posts five times in the past week, following brand A,” and “shared event B, three related comments.” The AI model outputs scores such as “cafe advertisement recommendation score 0.8, brand A advertisement recommendation score 0.7, event B advertisement recommendation score 0.6” based on these data. The advertisement unit, based on these output results, preferentially generates and presents advertisements highly relevant to the user's social media activity (e.g., video advertisement for a new product at a liked cafe, campaign advertisement for a followed brand, interactive advertisement for the latest information on a shared event). Examples of AI output include “video advertisement for new cafe product,” “brand A campaign banner,” and “interactive advertisement for latest event B information.” The advertisement unit uses these outputs for subsequent processing such as displaying advertisements on signage screens, push notifications to user terminals, and optimizing advertisement display frequency and timing. Furthermore, the advertisement unit continuously monitors changes in user advertisement reactions and social media activity, and optimizes AI model parameters through online learning. As a technical effect, the advertisement unit, unlike conventional static advertisement distribution or manual social analysis, realizes high-dimensional social data analysis and personalized advertisement generation by AI, thereby maximizing advertisement effectiveness, enhancing user experience, increasing advertising revenue, and reducing operational costs, resulting in improvements to computer technology itself. Specific application fields include advanced social-linked advertisement distribution services in public spaces such as bus stops at tourist sites, airports, train stations, shopping malls, hospitals, and public facilities. Additionally, variations of the AI model may include cooperation among multiple models for emotion estimation, behavior prediction, preference estimation, anomaly detection, cloud-edge cooperative processing, and anonymization for privacy protection, enabling diverse embodiments.

The system according to the embodiment is not limited to the examples described above and can be variously modified as follows, for example. Specifically, the present system can flexibly change and expand various technical elements such as AI model architecture and data flow, hardware configuration, communication methods, security functions, and user interface design. For example, as AI models, various neural network configurations can be adopted, including Transformer-based large language models, multimodal models combining CNN and RNN, optimization models based on reinforcement learning, and autoencoders for anomaly detection. Regarding data flow, optimization can be performed according to system requirements and operational environments, such as cloud-edge cooperative processing, distributed database management, real-time streaming analysis, and batch processing. As for hardware configuration, combinations of parallel computing clusters using GPUs, low-power edge devices, IoT sensor networks, and various peripheral devices such as displays, sensors, cameras, and microphones can be used. Communication methods can be selected according to the situation, including wireless communication standards such as Wi-Fi 6E, 5G, LPWA, Bluetooth LE, as well as wired LAN and optical fiber communication. Security functions can be implemented, such as data encryption, access control, unauthorized access monitoring by anomaly detection AI, anonymization for privacy protection, and distributed ID management. User interface design can also adopt various methods according to usage scenes and user attributes, such as touch panels, voice interaction, gesture recognition, gaze tracking, and multi-device cooperation. As a technical effect, the present system, by flexibly changing and expanding these technical elements, can respond quickly and efficiently to changes in operational environments and user needs, thereby improving system scalability, maintainability, operational efficiency, optimizing introduction costs, and continuously enhancing user experience, resulting in improvements to computer technology itself. Specific application fields include advanced information guidance, advertisement, communication, security, entertainment, and business support services in public, commercial, and industrial spaces such as bus stops at tourist sites, airports, train stations, shopping malls, hospitals, public facilities, factories, logistics hubs, educational institutions, and office buildings. Additionally, variations of the AI model may include cooperation among multiple models for emotion estimation, behavior prediction, image recognition, voice recognition, translation, anomaly detection, recommendation, optimization, cloud-edge-on-premises cooperative processing, privacy protection, security enhancement, autonomous fault recovery, and other diverse embodiments.

The provision unit is capable of estimating a user's emotion and adjusting the priority of information provided based on the estimated emotion of the user. For example, when the user is relaxed, the provision unit preferentially provides tourist guidance. When the user is in a hurry, the provision unit can preferentially provide information on the nearest hospital or ATM. When the user is feeling stressed, the provision unit can preferentially guide the location of restrooms. By adjusting the priority of information based on the user's emotion, the provision unit improves user convenience. Emotion estimation is realized using an emotion estimation function, for example, by employing an emotion engine or generative AI. Generative AI may include, for example, text generation AI (such as LLM) or multimodal generative AI, but is not limited thereto. Specifically, the provision unit inputs facial images (224×224 pixel RGB tensor), voice data (16 kHz sampling, one-dimensional array), text input (ID sequence of up to 512 tokens), and user behavioral logs (location information, terminal operation history, past usage history, etc., structured data) obtained from user terminals or signage terminals into an emotion estimation AI model. The emotion estimation AI model is configured as a multimodal neural network integrating a CNN for image recognition, an RNN for voice feature extraction, and a Transformer for text analysis. The AI model outputs emotion labels such as “relaxed,” “stressed,” and “in a hurry” in the form of probability distributions (e.g., relaxed 0.7, stressed 0.2, in a hurry 0.1) based on the input data. For example, outputs such as “relaxed 0.8, stressed 0.1, in a hurry 0.1” from facial images and voice data, and “in a hurry 0.6, relaxed 0.3, stressed 0.1” from text input are possible. The provision unit performs threshold judgment on these output results and inputs the emotion with the highest probability into an information priority control AI model. The information priority control AI model takes as input emotion labels, user attribute information, past usage history, current location information, and time zone, and outputs optimal information priority (e.g., tourist guidance priority, hospital guidance priority, restroom guidance priority). Examples of AI input include “emotion: relaxed 0.8, used tourist guidance three times in the past” and “emotion: in a hurry 0.7, current location is south side of bus stop.” Examples of AI output include “tourist guidance priority,” “hospital guidance priority,” and “restroom guidance priority.” The provision unit optimizes the order of information presentation on signage screens and user terminals in real time based on these outputs. Furthermore, the provision unit continuously collects user reactions (information viewing rate, guidance usage frequency, etc.) and updates AI model parameters through online learning. As a technical effect, the provision unit, unlike conventional uniform information presentation or manual guidance, realizes real-time, emotion-adaptive information priority optimization, thereby enhancing user experience, speeding up information acquisition, reducing misguidance, and reducing operational costs, resulting in improvements to computer technology itself. Specific application fields include advanced emotion-adaptive guidance services in public spaces such as bus stops at tourist sites, airports, train stations, shopping malls, hospitals, and public facilities. Additionally, variations of the AI model may include cooperation among multiple models for emotion estimation, behavior prediction, user attribute estimation, anomaly detection, cloud-edge cooperative processing, and anonymization for privacy protection, enabling diverse embodiments.

The provision unit is capable of providing personalized information based on the user's past behavior history. For example, the provision unit preferentially provides information on tourist sites previously visited by the user. The provision unit can provide information on hospitals previously used by the user. The provision unit can provide information on ATMs previously used by the user. By referring to past behavior history, the provision unit can provide optimal information. Specifically, the provision unit manages a behavior history database for each user, recorded in chronological order (structured data including tourist site ID, usage date and time, hospital ID, ATM usage history, search queries, device type, location information, etc.). When a user requests new information, the provision unit inputs past behavior history into an AI model (for example, a history analysis model based on RNN or Transformer that takes user behavior sequences as input) to extract history patterns and preferences. Examples of AI input include “visited tourist sites A and B, used hospital X twice, used ATM Y once in the past week” and “used ATM five times, used tourist sites twice in the past month.” The AI model outputs scores such as “tourist guidance priority 0.6, hospital guidance priority 0.3, ATM guidance priority 0.1” and “re-presentation recommendation score for previously used facilities” based on these history data. The provision unit, based on these output results, preferentially generates and presents information most relevant to the user (e.g., latest event information for previously visited tourist sites, updated consultation hours for used hospitals, changes in available hours for ATMs). Furthermore, to protect the privacy of history data, the provision unit implements anonymization and distributed database management, thoroughly utilizing history based on user consent. Examples of AI output include “latest event guidance for tourist site A,” “information on changes in medical departments at hospital X,” and “extension of available hours for ATM Y.” These outputs are used for subsequent processing such as displaying information on signage screens, push notifications to user terminals, and guidance via speech synthesis. As a technical effect, the provision unit, unlike conventional static information provision or manual history reference, realizes high-dimensional history analysis and personalized information generation by AI, thereby enhancing user experience, speeding up information acquisition, reducing misguidance, and reducing operational costs, resulting in improvements to computer technology itself. Specific application fields include advanced history-linked guidance services in public spaces such as bus stops at tourist sites, airports, train stations, shopping malls, hospitals, and public facilities. Additionally, variations of the AI model may include cooperation among multiple models for behavior prediction, preference estimation, anomaly detection, cloud-edge cooperative processing, and anonymization for privacy protection, enabling diverse embodiments.

The wireless LAN unit is capable of estimating a user's emotion and adjusting the connection range of the wireless LAN based on the estimated emotion of the user. For example, when the user is relaxed, the wireless LAN unit provides a normal connection range. When the user is in a hurry, the wireless LAN unit can provide a wide connection range. When the user is feeling stressed, the wireless LAN unit can provide a stable connection range. By adjusting the connection range based on the user's emotion, the wireless LAN unit improves user convenience. Emotion estimation is realized using an emotion estimation function, for example, by employing an emotion engine or generative AI. Generative AI may include, for example, text generation AI (such as LLM) or multimodal generative AI, but is not limited thereto. Specifically, the wireless LAN unit inputs facial images (224×224 pixel RGB tensor), voice data (16 kHz sampling, one-dimensional array), text input (ID sequence of up to 512 tokens), and behavioral logs including terminal operation history and location information (structured data) obtained from the user terminal into an emotion estimation AI model. The emotion estimation AI model is configured as a multimodal neural network integrating a CNN for image recognition, an RNN for voice feature extraction, and a Transformer for text analysis. The AI model outputs emotion labels such as “relaxed,” “stressed,” and “in a hurry” in the form of probability distributions (e.g., relaxed 0.6, in a hurry 0.3, stressed 0.1) based on the input data. For example, outputs such as “relaxed 0.7, in a hurry 0.2, stressed 0.1” from facial images and voice data, and “in a hurry 0.8, relaxed 0.1, stressed 0.1” from text input are possible. The wireless LAN unit performs threshold judgment on these output results and inputs the emotion with the highest probability into a connection range control AI model. The connection range control AI model takes as input emotion labels, device type, current communication load, application type, battery level, and physical placement information of access points, and outputs optimal connection range (e.g., radius 50 m, 100 m, 150 m), output power, antenna directivity, etc. Examples of AI input include “emotion: in a hurry 0.8, device: smartphone, current location: south side of bus stop” and “emotion: stressed 0.9, device: tablet, current location: inside waiting room.” Examples of AI output include “connection range: 150 m, output power: maximum” and “connection range: 50 m, stability prioritized.” The wireless LAN unit automatically issues output control signals and antenna control signals to access points based on the AI output, optimizing the connection range to user terminals in real time. Furthermore, the wireless LAN unit continuously collects user communication quality evaluations and usage status, and updates AI model parameters through online learning. As a technical effect, the wireless LAN unit, unlike conventional fixed connection range settings or manual adjustments, realizes real-time, emotion-adaptive connection range optimization, thereby improving communication quality, enhancing user experience, efficiently utilizing bandwidth resources, and reducing operational costs, resulting in improvements to computer technology itself. Specific application fields include advanced emotion-adaptive wireless communication services in public spaces such as bus stops at tourist sites, airports, train stations, shopping malls, hospitals, and public facilities. Additionally, variations of the AI model may include automatic reconfiguration during communication failures via anomaly detection, cloud-edge cooperative processing, anonymization for privacy protection, and fairness optimization among multiple users, enabling diverse embodiments.

The advertisement unit is capable of estimating a user's emotion and adjusting the display timing of advertisements based on the estimated emotion of the user. For example, when the user is relaxed, the advertisement unit sets the display timing of advertisements to normal. When the user is in a hurry, the advertisement unit can delay the display timing of advertisements. When the user is feeling stressed, the advertisement unit can advance the display timing of advertisements. By adjusting the display timing of advertisements based on the user's emotion, the advertisement unit enhances the effectiveness of advertisements. Emotion estimation is realized using an emotion estimation function, for example, by employing an emotion engine or generative AI. Generative AI may include, for example, text generation AI (such as LLM) or multimodal generative AI, but is not limited thereto. Specifically, the advertisement unit inputs facial images (224×224 pixel RGB tensor), voice data (16 kHz sampling, one-dimensional array), text input (ID sequence of up to 512 tokens), and user behavioral logs (location information, terminal operation history, past advertisement viewing history, etc., structured data) obtained from user terminals or signage terminals into an emotion estimation AI model. The emotion estimation AI model is configured as a multimodal neural network integrating a CNN for image recognition, an RNN for voice feature extraction, and a Transformer for text analysis. The AI model outputs emotion labels such as “relaxed,” “stressed,” and “in a hurry” in the form of probability distributions (e.g., relaxed 0.6, in a hurry 0.3, stressed 0.1) based on the input data. For example, outputs such as “relaxed 0.7, in a hurry 0.2, stressed 0.1” from facial images and voice data, and “in a hurry 0.8, relaxed 0.1, stressed 0.1” from text input are possible. The advertisement unit performs threshold judgment on these output results and inputs the emotion with the highest probability into an advertisement display timing control AI model. The advertisement display timing control AI model takes as input emotion labels, user attribute information, past advertisement reaction history, current time zone, and congestion status, and outputs optimal advertisement display timing (e.g., normal, delayed, immediate) and display start time. Examples of AI input include “emotion: relaxed 0.8, high past advertisement click rate” and “emotion: in a hurry 0.7, no advertisement reaction.” Examples of AI output include “display timing: normal,” “display timing: delayed,” and “display timing: immediate.” The advertisement unit optimizes the advertisement display timing on signage screens and user terminals in real time based on the AI output. Furthermore, the advertisement unit continuously collects user advertisement reactions (click rate, dwell time, etc.) and updates AI model parameters through online learning. As a technical effect, the advertisement unit, unlike conventional uniform display timing or manual adjustment, realizes real-time, emotion-adaptive advertisement display timing optimization, thereby maximizing advertisement effectiveness, enhancing user experience, increasing advertising revenue, and reducing operational costs, resulting in improvements to computer technology itself. Specific application fields include advanced emotion-adaptive advertisement distribution services in public spaces such as bus stops at tourist sites, airports, train stations, shopping malls, hospitals, and public facilities. Additionally, variations of the AI model may include cooperation among multiple models for emotion estimation, behavior prediction, user attribute estimation, anomaly detection, cloud-edge cooperative processing, and anonymization for privacy protection, enabling diverse embodiments.

The provision unit is capable of estimating a user's emotion and adjusting the format of information provided based on the estimated emotion of the user. For example, when the user is relaxed, the provision unit provides detailed information. When the user is in a hurry, the provision unit can provide concise information focusing on key points. When the user is feeling stressed, the provision unit can provide simple information. By adjusting the format of information based on the user's emotion, the provision unit improves user convenience. Emotion estimation is realized using an emotion estimation function, for example, by employing an emotion engine or generative AI. Generative AI may include, for example, text generation AI (such as LLM) or multimodal generative AI, but is not limited thereto. Specifically, the provision unit inputs facial images (224×224 pixel RGB tensor), voice data (16 kHz sampling, one-dimensional array), text input (ID sequence of up to 512 tokens), and user behavioral logs (location information, terminal operation history, past usage history, etc., structured data) obtained from user terminals or signage terminals into an emotion estimation AI model. The emotion estimation AI model is configured as a multimodal neural network integrating a CNN for image recognition, an RNN for voice feature extraction, and a Transformer for text analysis. The AI model outputs emotion labels such as “relaxed,” “stressed,” and “in a hurry” in the form of probability distributions (e.g., relaxed 0.7, stressed 0.2, in a hurry 0.1) based on the input data. For example, outputs such as “relaxed 0.8, stressed 0.1, in a hurry 0.1” from facial images and voice data, and “in a hurry 0.6, relaxed 0.3, stressed 0.1” from text input are possible. The provision unit performs threshold judgment on these output results and inputs the emotion with the highest probability into an information format control AI model. The information format control AI model takes as input emotion labels, user attribute information, device type, past usage history, current location information, and time zone, and outputs optimal information format (e.g., detailed text, key point bullet list, simple map image, voice guidance, etc.). Examples of AI input include “emotion: relaxed 0.8, device: tablet” and “emotion: in a hurry 0.7, device: smartphone.” Examples of AI output include “detailed guidance text,” “bullet list of key points only,” and “simple map image.” The provision unit optimizes the information display format on signage screens and user terminals in real time based on these outputs. Furthermore, the provision unit continuously collects user reactions (information viewing rate, guidance usage frequency, etc.) and updates AI model parameters through online learning. As a technical effect, the provision unit, unlike conventional uniform information formats or manual guidance, realizes real-time, emotion-adaptive information format optimization, thereby enhancing user experience, speeding up information acquisition, reducing misguidance, and reducing operational costs, resulting in improvements to computer technology itself. Specific application fields include advanced emotion-adaptive guidance services in public spaces such as bus stops at tourist sites, airports, train stations, shopping malls, hospitals, and public facilities. Additionally, variations of the AI model may include cooperation among multiple models for emotion estimation, behavior prediction, user attribute estimation, anomaly detection, cloud-edge cooperative processing, and anonymization for privacy protection, enabling diverse embodiments.

The provision unit is capable of providing appropriate information based on the user's current weather information. For example, during rainy weather, the provision unit provides information on the nearest indoor facilities. During sunny weather, the provision unit can provide information on outdoor tourist sites. On snowy days, the provision unit can provide information on warm places. By considering weather information, the provision unit can provide optimal information. Specifically, the provision unit receives weather information obtained from weather sensors or external weather APIs (structured data including precipitation, temperature, humidity, weather type, wind speed, snow accumulation, etc.) in real time. The provision unit inputs this weather information, along with the user's current location information, past usage history, device type, etc., into an AI model (for example, a recommendation model that takes weather information and facility attributes as input, or a personalized model that considers user behavior history) to generate/select optimal information (e.g., indoor facility guidance, outdoor tourist site guidance, guidance for facilities with heating equipment, etc.). Examples of AI input include “weather: rain, temperature: 15° C., current location: north side of bus stop” and “weather: sunny, temperature: 25° C., current location: in front of the station.” Examples of AI output include “guidance text for nearest indoor facility,” “map image of outdoor tourist site,” and “coupon for a warm cafe.” The provision unit uses these outputs for subsequent processing such as displaying information on signage screens, push notifications to user terminals, and guidance via speech synthesis. Furthermore, the provision unit continuously monitors weather changes and user reactions, and optimizes AI model parameters through online learning. As a technical effect, the provision unit, unlike conventional static information provision or manual weather judgment, realizes real-time, weather-adaptive information optimization, thereby enhancing user experience, speeding up information acquisition, reducing misguidance, and reducing operational costs, resulting in improvements to computer technology itself. Specific application fields include advanced weather-linked guidance services in public spaces such as bus stops at tourist sites, airports, train stations, shopping malls, hospitals, and public facilities. Additionally, variations of the AI model may include automatic guidance switching during sudden weather changes via anomaly detection, cloud-edge cooperative processing, and anonymization for privacy protection, enabling diverse embodiments.

The wireless LAN unit is capable of determining the priority of connection according to the type of user's device. For example, when a smartphone is used, the wireless LAN unit performs connection settings optimized for the smartphone. When a tablet is used, the wireless LAN unit can perform connection settings optimized for the tablet. When a laptop is used, the wireless LAN unit can perform connection settings optimized for the laptop. By performing optimal connection settings according to the device type, the wireless LAN unit improves connection convenience. Specifically, the wireless LAN unit inputs device information obtained from the user terminal (structured data including device type: smartphone, tablet, laptop, OS type, screen size, wireless standard compatibility, battery level, etc.) into a connection setting optimization AI model (for example, a rule-based model or reinforcement learning model that takes device attributes and usage status as input) to determine optimal connection settings (e.g., bandwidth allocation, channel selection, transmission power, QoS parameters, security protocol selection, etc.). Examples of AI input include “device type: smartphone, OS: Android, screen size 6 inches,” “device type: tablet, OS: iOS, screen size 10 inches,” and “device type: laptop, OS: Windows, Wi-Fi 6 compatible.” Examples of AI output include “bandwidth: 20 Mbps, channel: 36, QoS: standard,” “bandwidth: 50 Mbps, channel: 44, QoS: high,” and “bandwidth: 100 Mbps, channel: 149, QoS: highest.” The wireless LAN unit automatically changes access point setting parameters based on the AI output and provides the optimal connection environment to each terminal in real time. Furthermore, the wireless LAN unit continuously monitors communication quality for each terminal (throughput, latency, packet loss, etc.) and application type (video, web, game, etc.), and optimizes AI model parameters through online learning. As a technical effect, the wireless LAN unit, unlike conventional uniform settings or manual device configuration, realizes real-time, device-adaptive connection optimization, thereby improving communication quality, enhancing user experience, efficiently utilizing bandwidth resources, and reducing operational costs, resulting in improvements to computer technology itself. Specific application fields include advanced multi-device wireless communication services in public spaces such as bus stops at tourist sites, airports, train stations, shopping malls, hospitals, and public facilities. Additionally, variations of the AI model may include automatic reconfiguration during device failures via anomaly detection, cloud-edge cooperative processing, and anonymization for privacy protection, enabling diverse embodiments.

The advertisement unit can distribute region-specific advertisements by taking into account the user's current location information. For example, it can distribute advertisements for stores near the user's current location, or advertisements for events related to the user's current location. It can also distribute region-limited coupons based on the user's current location. Thus, by considering location information, the advertisement unit can distribute region-specific advertisements. Specifically, the advertisement unit receives current location information (such as GPS coordinates: latitude and longitude numerical vectors, Wi-Fi triangulation results, beacon IDs, etc.) in real time from user terminals or signage terminals. The advertisement unit matches this location information with a regional facility database (storing coordinates, attributes, advertisement inventory information, etc. for each facility), and uses distance calculation algorithms (e.g., Euclidean distance, Haversine distance) or route search algorithms (e.g., A*, Dijkstra's algorithm) to identify the nearest facility. AI models (for example, ranking models that take location information and facility attributes as input, or recommendation models that consider user movement history) output a scored list such as “Store A: 50 m away, Event B: 100 m away, Coupon C: within valid range.” Examples of AI input include “Current location: latitude 35.1234, longitude 139.5678” or “Current location: south side of bus stop, movement direction: east.” Examples of AI output include “Discount coupon for the nearest cafe,” “Banner advertisement for the event in front of the station,” or “Video advertisement for a region-limited shop.” Based on these outputs, the advertisement unit performs subsequent processing such as displaying advertisements on signage screens, push notifications to user terminals, and optimizing advertisement display frequency and timing. Furthermore, the advertisement unit can also consider the user's movement speed and congestion status to propose optimal advertisement delivery timing or route changes. As a technical effect, unlike conventional static advertisement delivery or manual map guidance, the advertisement unit achieves real-time and highly accurate location information analysis and region-specific advertisement recommendation, thereby improving advertisement effectiveness, enhancing user experience, increasing advertising revenue, and reducing operational costs, thus improving computer technology itself. Specific application fields include advanced location-linked advertisement delivery services in public spaces such as bus stops in tourist areas, airports, train stations, shopping malls, hospitals, and public facilities. Additionally, variations of the AI model may include congestion avoidance advertisement delivery through anomaly detection, cloud-edge cooperative processing, anonymization processing for privacy protection, and other diverse embodiments.

The provision unit can push information notifications to a smartphone based on the user's device information. For example, if the user is using a smartphone, information is pushed to the smartphone; if the user is using a tablet, information can be pushed to the tablet; if the user is using a smartwatch, information can be pushed to the smartwatch. Thus, by considering device information, the provision unit can appropriately push notifications. Specifically, the provision unit takes device information obtained from the user terminal (structured data including device type: smartphone, tablet, smartwatch, OS type, screen size, notification permission settings, etc.) as input, and uses a push notification control AI model (for example, a rule-based model or reinforcement learning model that takes device attributes and usage status as input) to determine the optimal notification timing, content, and format (text, image, audio, link, etc.). Examples of AI input include “Device type: smartphone, notification permission ON,” “Device type: tablet, screen size 10 inches,” or “Device type: smartwatch, notification permission ON.” Examples of AI output include “Notify tourist guidance text to smartphone,” “Notify map image to tablet,” or “Notify only key points to smartwatch.” Based on these outputs, the provision unit pushes information via the notification API of each device's OS or application. Furthermore, the provision unit collects user responses to notifications (open rate, click rate, notification rejection rate, etc.) in real time and optimizes the AI model parameters through online learning. As a technical effect, unlike conventional uniform notifications or manual delivery, the provision unit achieves real-time and device-adaptive notification optimization, thereby improving information reach rate, enhancing user experience, maximizing notification effectiveness, and reducing operational costs, thus improving computer technology itself. Specific application fields include advanced multi-device information notification services in public spaces such as bus stops in tourist areas, airports, train stations, shopping malls, hospitals, and public facilities. Additionally, variations of the AI model may include cooperation among multiple models for behavior prediction, emotion estimation, device attribute estimation, cloud-edge cooperative processing, anonymization processing for privacy protection, and other diverse embodiments.

The wireless LAN unit can refer to the user's connection history to determine the priority of connection. For example, it can prioritize connection for users who have frequently connected in the past, users whose past connections were unstable, or users whose past connections were stable. Thus, by referring to connection history, the wireless LAN unit can appropriately determine connection priority. Specifically, the wireless LAN unit manages a connection history database recorded chronologically for each user (structured data including connection date and time, connection duration, number of disconnections, communication quality indicators, device type, used applications, etc.). When a user issues a new connection request, the wireless LAN unit inputs the past connection history into an AI model (for example, a history analysis model based on RNN or Transformer that takes user connection sequences as input) to calculate connection stability and priority scores. Examples of AI input include “Connected 5 times in the past week, 1 disconnection, average communication speed 20 Mbps,” or “Connected 10 times in the past month, 0 disconnections, average latency 30 ms.” The AI model outputs scores such as “Priority score 0.9,” “Stability score 0.8,” or “Reconnection recommendation score 0.7” based on these history data. Based on these outputs, the wireless LAN unit grants connection permission and allocates bandwidth in order of priority, even when there are many simultaneous users. Furthermore, to protect the privacy of connection history, the wireless LAN unit implements anonymization processing and distributed database management, thoroughly utilizing history based on user consent. Examples of AI output include “Priority connection permission,” “Reconnection recommendation,” or “Bandwidth increase.” These outputs are used for subsequent processing such as access point control signals or connection notifications to user terminals. As a technical effect, unlike conventional uniform connections or manual history reference, the wireless LAN unit achieves high-dimensional history analysis and priority optimization by AI, thereby improving communication quality, reducing disconnection rates, enhancing user experience, and reducing operational costs, thus improving computer technology itself. Specific application fields include advanced history-linked wireless communication services in public spaces such as bus stops in tourist areas, airports, train stations, shopping malls, hospitals, and public facilities. Additionally, variations of the AI model may include cooperation among multiple models for behavior prediction, anomaly detection, device attribute estimation, cloud-edge cooperative processing, anonymization processing for privacy protection, and other diverse embodiments.

The following is a brief explanation of the processing flow of Example of the Embodiment. Specifically, in this system, each module—the installation unit, provision unit, wireless LAN unit, and advertisement unit—cooperates to integratively analyze user input, environmental information, history data, emotion estimation results, and other high-dimensional data, thereby providing real-time and personalized information, advertisement, and communication services. The installation unit optimizes the physical installation position, height, angle, lighting conditions, and security monitoring of the digital signage terminal using AI models. The provision unit analyzes various user inputs such as voice, text, image, location information, and device information using large-scale multilingual language models and multimodal neural networks, and generates and presents optimal guidance information. The wireless LAN unit analyzes device attributes, usage status, emotion, history, battery level, location information, etc. of user terminals using AI models, and dynamically optimizes bandwidth allocation, connection priority, AP selection, and QoS parameters. The advertisement unit analyzes user emotion, behavior history, location information, device information, social media activity, etc. using AI models, determines optimal advertisement content, display frequency, timing, notification destination device, etc., and maximizes advertisement effectiveness. Each unit combines online learning of AI models, cloud-edge cooperative processing, anonymization processing for privacy protection, and security enhancement through anomaly detection, thereby continuously improving the operational efficiency, scalability, and user experience of the entire system. As a technical effect, unlike conventional static and uniform information, advertisement, and communication services or manual operation, this system achieves personalized optimization based on real-time and high-dimensional data analysis, thereby improving user experience, maximizing advertising revenue, efficiently utilizing communication resources, reducing operational costs, and improving computer technology itself. Specific application fields include advanced multilingual guidance, advertisement, communication, security, and entertainment services in public spaces such as bus stops in tourist areas, airports, train stations, shopping malls, hospitals, and public facilities. Additionally, variations of the AI model may include cooperation among multiple models for emotion estimation, behavior prediction, image recognition, speech recognition, translation, anomaly detection, recommendation, optimization, cloud-edge-on-premises cooperative processing, privacy protection, security enhancement, autonomous fault recovery, and other diverse embodiments.
Step 1: The installation unit installs digital signage. The digital signage is installed, for example, in the waiting room of a bus stop or around the bus stop. Step 2: The provision unit provides information in multiple languages using the digital signage installed by the installation unit. For example, information such as tourist guidance, hospital guidance, ATM guidance, and restroom guidance is provided in multiple languages. Information can be generated using AI, such as a text generation AI (e.g., LLM). Step 3: The wireless LAN unit provides wireless LAN at the bus stop. For example, wireless LAN conforming to the IEEE 802.11 standard can be provided in the waiting room of the bus stop or around the bus stop. Step 4: The advertisement unit distributes advertisements to the digital signage. For example, video advertisements, banner advertisements, and targeted advertisements can be displayed on digital signage installed at the bus stop to provide users with information about products and services. The advertisement unit can distribute advertisements using an AI model that takes user attribute information as input and outputs advertisement content. Specifically, in Step 1, the installation unit optimizes installation position, height, angle, lighting conditions, security monitoring, etc. using AI models (e.g., environment recognition CNN, flow line analysis LSTM, lighting control reinforcement learning model, anomaly detection AutoEncoder), and continuously collects data from sensors, cameras, microphones, etc. after installation to update the installation optimization algorithm through online learning. In Step 2, the provision unit inputs user input (voice: 1D array sampled at 16 kHz, text: up to 512 token ID sequence, image: 224×224 pixel RGB tensor, location information: latitude-longitude vector, device information: OS type, language settings, etc.) into large-scale multilingual language models and multimodal neural networks (e.g., Transformer-based multilingual models, integrated image, voice, and text models), and generates outputs such as multilingual text, map images, route guidance data (JSON format), which are used for subsequent processing such as signage screen display, device push notifications, and speech synthesis reading. In Step 3, the wireless LAN unit analyzes device attributes, usage status, emotion, history, battery level, location information, etc. of user terminals using AI models (e.g., reinforcement learning model for bandwidth allocation optimization, ranking model for AP selection, QoS control model), and dynamically optimizes bandwidth allocation, connection priority, AP selection, QoS parameters, and issues access point control signals. In Step 4, the advertisement unit analyzes user emotion, behavior history, location information, device information, social media activity, etc. using AI models (e.g., multimodal model for emotion estimation, RNN for history analysis, location-linked recommendation model), determines optimal advertisement content, display frequency, timing, notification destination device, etc., and executes subsequent processing such as signage screen display, device push notifications, and advertisement effectiveness analysis. In each step, online learning of AI models, cloud-edge cooperative processing, anonymization processing for privacy protection, and security enhancement through anomaly detection are combined to continuously improve the operational efficiency, scalability, and user experience of the entire system. As a technical effect, unlike conventional static and uniform information, advertisement, and communication services or manual operation, this system achieves personalized optimization based on real-time and high-dimensional data analysis, thereby improving user experience, maximizing advertising revenue, efficiently utilizing communication resources, reducing operational costs, and improving computer technology itself. Specific application fields include advanced multilingual guidance, advertisement, communication, security, and entertainment services in public spaces such as bus stops in tourist areas, airports, train stations, shopping malls, hospitals, and public facilities. Additionally, variations of the AI model may include cooperation among multiple models for emotion estimation, behavior prediction, image recognition, speech recognition, translation, anomaly detection, recommendation, optimization, cloud-edge-on-premises cooperative processing, privacy protection, security enhancement, autonomous fault recovery, and other diverse embodiments.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the above-mentioned installation unit, provision unit, wireless LAN unit, and advertisement unit, which are among a plurality of elements, is implemented by at least one of, for example, a smart device 14 and a data processing apparatus 12. For example, the installation unit is implemented by the smart device 14 and installs digital signage at a bus stop. The provision unit is implemented, for example, by a specific processing unit 290 of the data processing apparatus 12 and provides information such as tourist guidance, hospital guidance, ATM guidance, and restroom guidance in multiple languages. The wireless LAN unit is implemented, for example, by a communication I/F 44 of the smart device 14 and provides wireless LAN at the bus stop. The advertisement unit is implemented, for example, by the specific processing unit 290 of the data processing apparatus 12 and distributes advertisements to the digital signage. The correspondence between each unit and the apparatus or control unit is not limited to the above examples and various modifications are possible.

### Second Embodiment

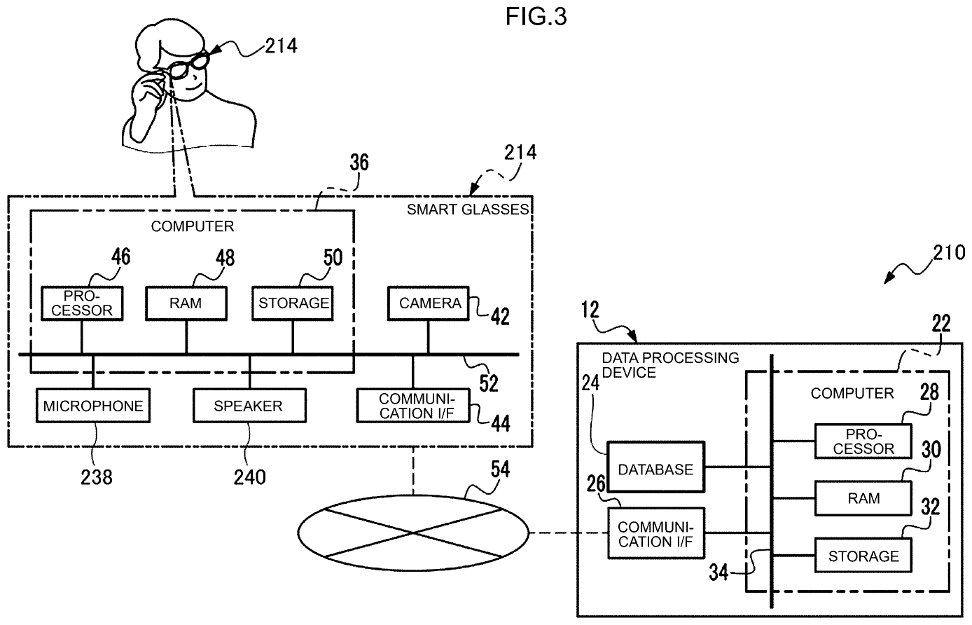

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

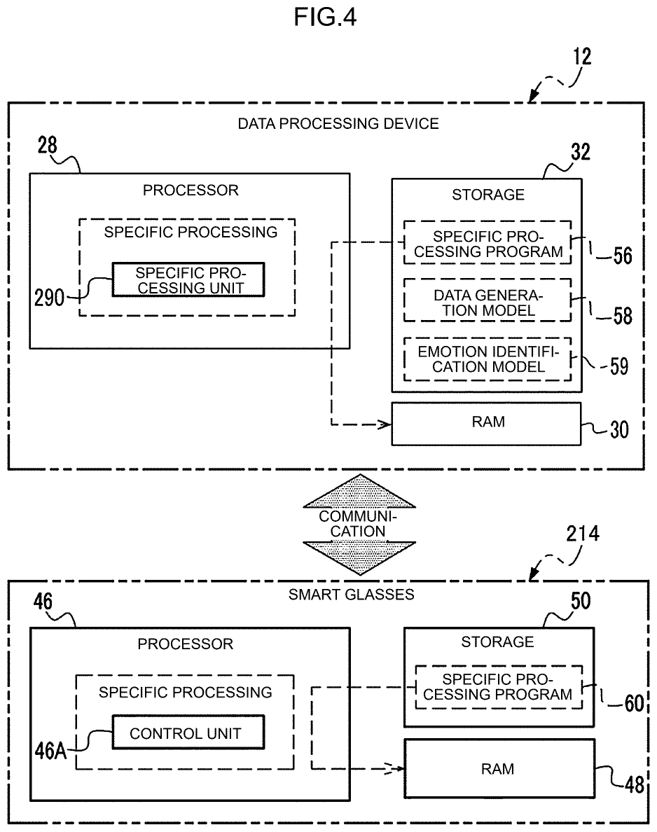

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the above-mentioned installation unit, provision unit, wireless LAN unit, and advertisement unit, which are among a plurality of elements, is implemented by at least one of, for example, smart glasses 214 and a data processing apparatus 12. For example, the installation unit is implemented by the smart glasses 214 and installs digital signage at a bus stop. The provision unit is implemented, for example, by a specific processing unit 290 of the data processing apparatus 12 and provides information such as tourist guidance, hospital guidance, ATM guidance, and restroom guidance in multiple languages. The wireless LAN unit is implemented, for example, by a communication I/F 44 of the smart glasses 214 and provides wireless LAN at the bus stop. The advertisement unit is implemented, for example, by the specific processing unit 290 of the data processing apparatus 12 and distributes advertisements to the digital signage. The correspondence between each unit and the apparatus or control unit is not limited to the above examples and various modifications are possible.

### Third Embodiment

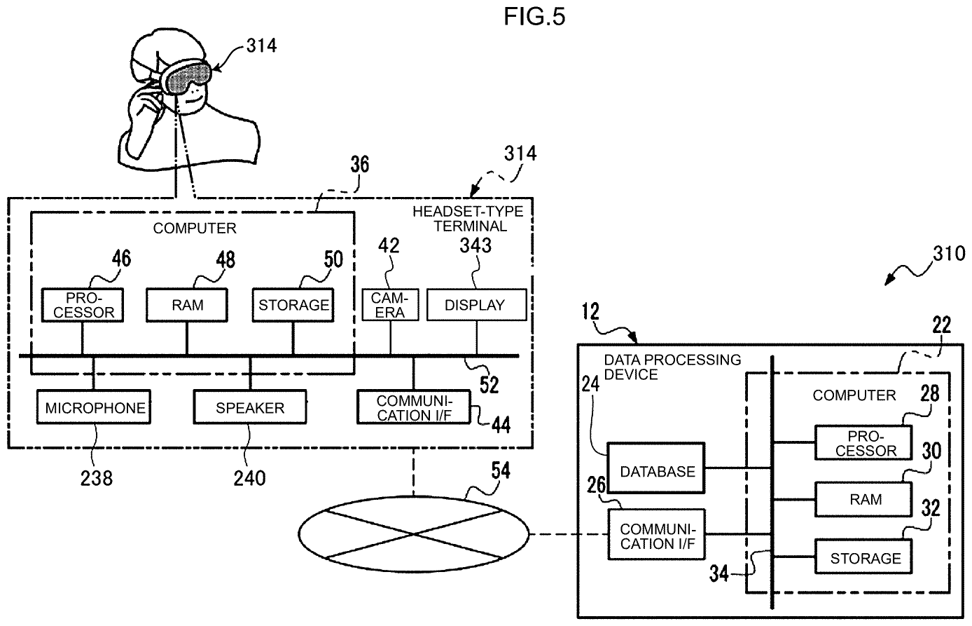

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

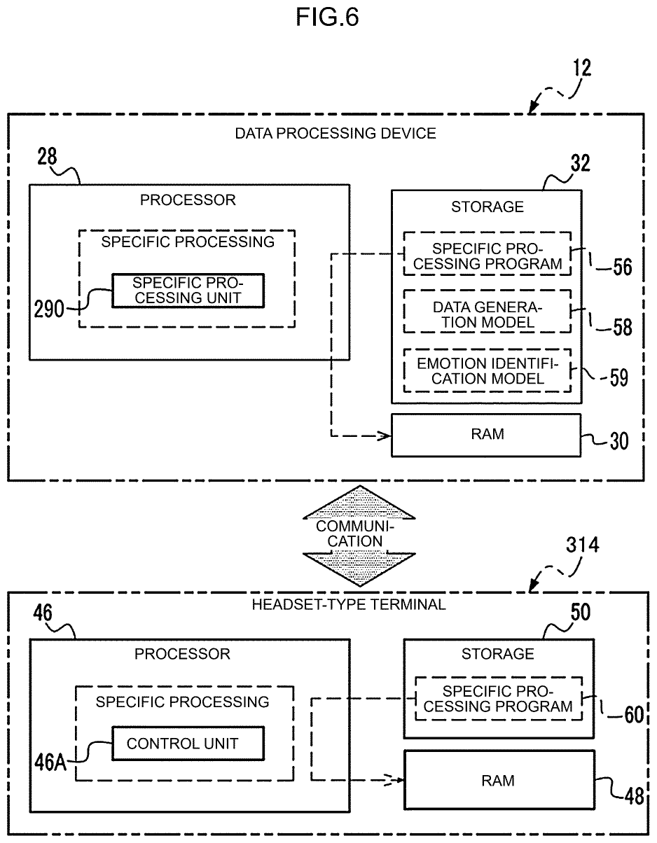

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the above-mentioned installation unit, provision unit, wireless LAN unit, and advertisement unit, which are among a plurality of elements, is implemented by at least one of, for example, a headset-type terminal 314 and a data processing apparatus 12. For example, the installation unit is implemented by the headset-type terminal 314 and installs digital signage at a bus stop. The provision unit is implemented, for example, by a specific processing unit 290 of the data processing apparatus 12 and provides information such as tourist guidance, hospital guidance, ATM guidance, and restroom guidance in multiple languages. The wireless LAN unit is implemented, for example, by a communication I/F 44 of the headset-type terminal 314 and provides wireless LAN at the bus stop. The advertisement unit is implemented, for example, by the specific processing unit 290 of the data processing apparatus 12 and distributes advertisements to the digital signage. The correspondence between each unit and the apparatus or control unit is not limited to the above examples and various modifications are possible.

### Fourth Embodiment

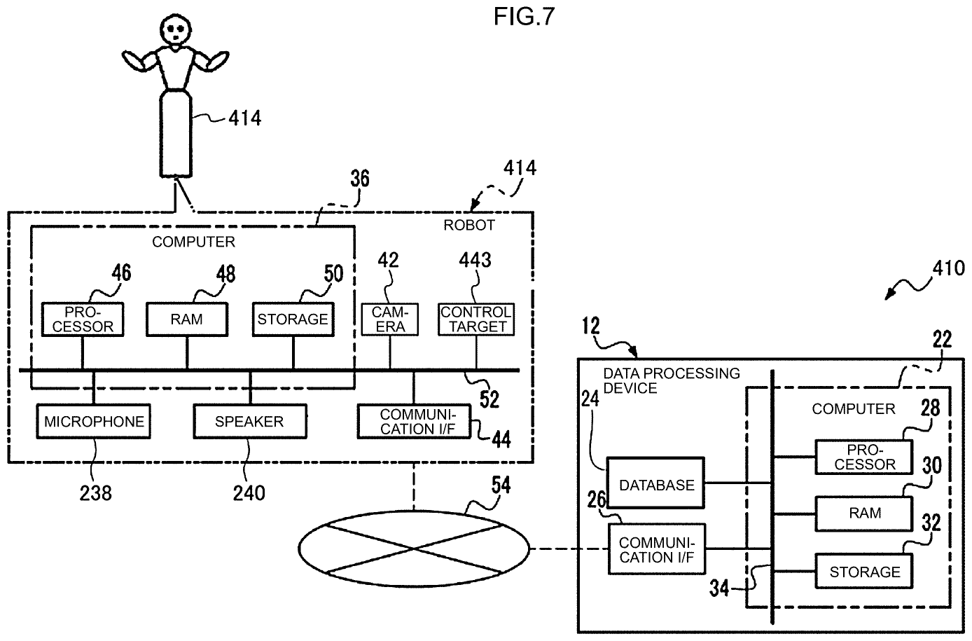

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

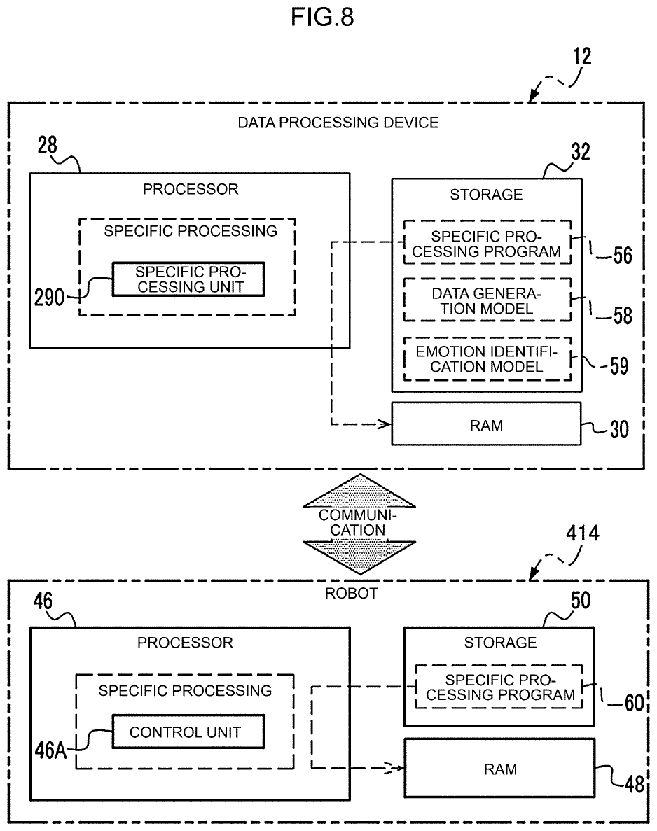

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the above-mentioned installation unit, provision unit, wireless LAN unit, and advertisement unit, which are among a plurality of elements, is implemented by at least one of, for example, a robot 414 and a data processing apparatus 12. For example, the installation unit is implemented by the robot 414 and installs digital signage at a bus stop. The provision unit is implemented, for example, by a specific processing unit 290 of the data processing apparatus 12 and provides information such as tourist guidance, hospital guidance, ATM guidance, and restroom guidance in multiple languages. The wireless LAN unit is implemented, for example, by a communication I/F 44 of the robot 414 and provides wireless LAN at the bus stop. The advertisement unit is implemented, for example, by the specific processing unit 290 of the data processing apparatus 12 and distributes advertisements to the digital signage. The correspondence between each unit and the apparatus or control unit is not limited to the above examples and various modifications are possible.

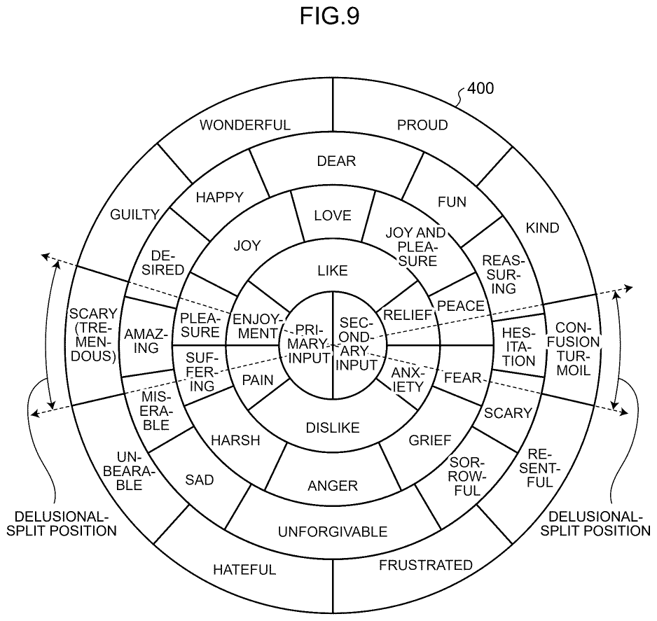

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

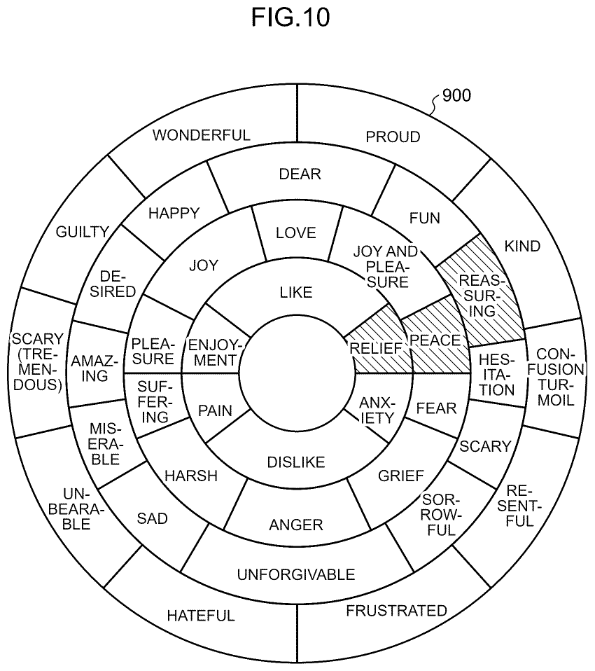

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1)A system comprising: an installation unit configured to install digital signage; a provision unit configured to provide information in multiple languages using the digital signage installed by the installation unit; a wireless LAN unit configured to provide wireless LAN; and an advertisement unit configured to distribute advertisements.
(Supplementary Note 2)The system according to Supplementary Note 1, wherein the provision unit is configured to provide information on tourist guidance, hospital guidance, ATM guidance, and restroom guidance in multiple languages.
(Supplementary Note 3)The system according to Supplementary Note 1, wherein the wireless LAN unit is configured to provide wireless LAN at bus stops to facilitate use of smartphones by users.
(Supplementary Note 4)The system according to Supplementary Note 1, wherein the advertisement unit is configured to distribute advertisements to the digital signage and increase advertising revenue.
(Supplementary Note 5)The system according to Supplementary Note 1, wherein the provision unit is configured to display bus arrival times in real time.
(Supplementary Note 6)The system according to Supplementary Note 1, wherein the provision unit is configured to provide entertainment content.
(Supplementary Note 7)The system according to Supplementary Note 1, wherein the installation unit is configured to estimate a user's emotion and optimize the installation location of the digital signage based on the estimated emotion of the user.
(Supplementary Note 8)The system according to Supplementary Note 1, wherein the installation unit is configured to select an appropriate installation position based on the surrounding environment or user flow lines.
(Supplementary Note 9)The system according to Supplementary Note 1, wherein the installation unit is configured to adjust surrounding lighting conditions to improve the visibility of the digital signage.
(Supplementary Note 10)The system according to Supplementary Note 1, wherein the installation unit is configured to estimate a user's emotion and adjust the installation height of the digital signage based on the estimated emotion of the user.
(Supplementary Note 11)The system according to Supplementary Note 1, wherein the installation unit is configured to adjust the installation angle of the digital signage to make information easier for users to view.
(Supplementary Note 12)The system according to Supplementary Note 1, wherein the installation unit is configured to install a security camera at the installation location of the digital signage to enhance security.
(Supplementary Note 13)The system according to Supplementary Note 1, wherein the provision unit is configured to estimate a user's emotion and adjust the content of information provided based on the estimated emotion of the user.
(Supplementary Note 14)The system according to Supplementary Note 1, wherein the provision unit is configured to provide appropriate information based on the user's past usage history.
(Supplementary Note 15)The system according to Supplementary Note 1, wherein the provision unit is configured to preferentially provide information on the nearest facility based on the user's current location information.
(Supplementary Note 16)The system according to Supplementary Note 1, wherein the provision unit is configured to estimate a user's emotion and adjust the display method of information provided based on the estimated emotion of the user.
(Supplementary Note 17)The system according to Supplementary Note 1, wherein the provision unit is configured to automatically switch the display language of information based on the user's language settings.
(Supplementary Note 18)The system according to Supplementary Note 1, wherein the provision unit is configured to push information notifications to a smartphone based on the user's device information.
(Supplementary Note 19)The system according to Supplementary Note 1, wherein the wireless LAN unit is configured to estimate a user's emotion and adjust the connection speed of the wireless LAN based on the estimated emotion of the user.
(Supplementary Note 20)The system according to Supplementary Note 1, wherein the wireless LAN unit is configured to perform appropriate connection settings according to the type of user's device.
(Supplementary Note 21)The system according to Supplementary Note 1, wherein the wireless LAN unit is configured to refer to the user's connection history and determine the priority of connection.
(Supplementary Note 22)The system according to Supplementary Note 1, wherein the wireless LAN unit is configured to estimate a user's emotion and adjust the connection time of the wireless LAN based on the estimated emotion of the user.
(Supplementary Note 23)The system according to Supplementary Note 1, wherein the wireless LAN unit is configured to select an appropriate access point based on the user's location information.
(Supplementary Note 24)The system according to Supplementary Note 1, wherein the wireless LAN unit is configured to determine the priority of connection based on the battery level of the user's device.
(Supplementary Note 25)The system according to Supplementary Note 1, wherein the advertisement unit is configured to estimate a user's emotion and adjust the content of advertisements based on the estimated emotion of the user.
(Supplementary Note 26)The system according to Supplementary Note 1, wherein the advertisement unit is configured to refer to the user's past advertisement viewing history and distribute optimal advertisements.
(Supplementary Note 27)The system according to Supplementary Note 1, wherein the advertisement unit is configured to distribute region-specific advertisements in consideration of the user's current location information.
(Supplementary Note 28)The system according to Supplementary Note 1, wherein the advertisement unit is configured to estimate a user's emotion and adjust the display frequency of advertisements based on the estimated emotion of the user.
(Supplementary Note 29)The system according to Supplementary Note 1, wherein the advertisement unit is configured to push advertisement notifications to a smartphone in consideration of the user's device information.
(Supplementary Note 30)The system according to Supplementary Note 1, wherein the advertisement unit is configured to analyze the user's social media activity and distribute relevant advertisements.

What is claimed is:

1. A system comprising:
circuitry configured to:
receive, via a communication interface coupled to a packet-switched network, multimodal input data comprising at least voice waveform data and location data from a terminal device;
process the multimodal input data using a multilingual neural network model comprising a Transformer-based encoder that receives the voice waveform data as a one-dimensional sampled array and generates a token sequence, and generate localized content data in a plurality of languages based on the token sequence and the location data;
determine, using an emotion identification model comprising a multimodal neural network integrating a convolutional neural network for image recognition and a recurrent neural network for voice feature extraction, an emotion label from the multimodal input data, the emotion label output as a probability distribution over a plurality of emotion categories; and
configure access point parameters for a wireless access node based on device attribute data received from the terminal device, the access point parameters comprising at least bandwidth allocation and quality-of-service settings determined by a reinforcement learning model that receives the device attribute data and a connection history as input.

2. The system according to claim 1, wherein the multimodal input data further comprises text data and image data captured by the terminal device, and wherein the multilingual neural network model is a multimodal model that integrally processes the voice waveform data, the text data, and the image data as respective multidimensional tensors.

3. The system according to claim 1, wherein the voice waveform data comprises a one-dimensional array sampled at 16 kHz, and wherein the Transformer-based encoder converts the voice waveform data into text via a voice recognition engine and provides the text as an input tensor comprising a token identifier sequence with a maximum length of 512 tokens to the multilingual neural network model.

4. The system according to claim 1, wherein the localized content data comprises multilingual text output and structured data in a serialized format including coordinate values and landmark identifiers for route guidance.

5. The system according to claim 1, wherein the circuitry is further configured to generate, using the localized content data, at least one of a push notification transmitted to the terminal device, a synthesized voice output, or a display output rendered on a display device coupled to the circuitry.

6. The system according to claim 1, wherein the plurality of emotion categories comprises at least relaxed, stressed, and in a hurry, and wherein the circuitry is further configured to adjust a content category of the localized content data based on the emotion label having a highest probability value among the plurality of emotion categories.

7. The system according to claim 6, wherein the circuitry is further configured to, when the emotion label indicates stressed, prioritize generation of localized content data identifying a nearest facility, and when the emotion label indicates relaxed, prioritize generation of localized content data comprising informational guidance content.

8. The system according to claim 1, wherein the circuitry is further configured to adjust a display format of the localized content data based on the emotion label, the display format comprising at least one of detailed text, a key-point summary, a map image, or a voice guidance output.

9. The system according to claim 1, wherein the device attribute data comprises at least a device type, an operating system type, a battery level, and an application type, and wherein the reinforcement learning model outputs the bandwidth allocation and a channel selection for the wireless access node.

10. The system according to claim 1, wherein the circuitry is further configured to monitor communication quality for the terminal device comprising at least throughput, latency, and packet loss, and to update parameters of the reinforcement learning model through online learning based on the monitored communication quality.

11. The system according to claim 1, wherein the circuitry is further configured to select, using a recommendation model that receives user attribute data and behavioral history data as input, content for distribution to a display device, the recommendation model comprising at least one of a reinforcement-learning-based bandit algorithm or a recurrent neural network that receives a user behavior sequence as input.

12. The system according to claim 11, wherein the user attribute data comprises at least an age group, a past viewing history, and the emotion label, and wherein the recommendation model outputs an identifier of selected content and a display timing parameter.

13. The system according to claim 1, wherein the circuitry is further configured to receive weather data from an external data source and to adjust the localized content data based on the weather data, such that the localized content data identifies indoor facilities when the weather data indicates precipitation and identifies outdoor locations when the weather data indicates clear conditions.

14. The system according to claim 1, wherein the circuitry is further configured to manage a usage history database for each user recorded in chronological order, the usage history database comprising facility identifiers, usage timestamps, and search queries, and to input the usage history database into a history analysis model based on a recurrent neural network or a Transformer to extract preference patterns and generate a priority score for each content category.

15. The system according to claim 1, wherein the circuitry is further configured to determine a connection priority for the terminal device based on the connection history, the connection history comprising a number of past connections, a number of disconnections, an average communication speed, and an average latency, and wherein the reinforcement learning model outputs a priority score and a reconnection recommendation score.

16. The system according to claim 1, wherein the circuitry is further configured to select an access point from a plurality of wireless access nodes based on the location data of the terminal device and a congestion status of each of the plurality of wireless access nodes, and to perform handover and load balancing between the plurality of wireless access nodes using the reinforcement learning model.

17. The system according to claim 1, wherein the circuitry is further configured to input video data from a security camera into an anomaly detection model comprising a multimodal neural network combining a convolutional neural network for image recognition, a recurrent neural network for voice anomaly detection, and a long short-term memory network for time-series analysis, and to output an anomaly label as a probability distribution and transmit a warning signal when the anomaly label exceeds a threshold.

18. A system comprising:
a processor comprising at least one of a central processing unit, a graphics processing unit, a tensor processing unit, a field-programmable gate array, or an application-specific integrated circuit;
a memory coupled to the processor, the memory storing a multilingual neural network model, an emotion identification model, and a reinforcement learning model;
a communication interface coupled to the processor and to a packet-switched network comprising at least one of a wide area network or a local area network, the communication interface comprising a communication processor and an antenna supporting at least one of a fifth-generation mobile communication standard, Wi-Fi, or Bluetooth;
a database coupled to the processor via a bus, the database storing user attribute data and connection history data; and
circuitry configured to:
receive, via the communication interface, multimodal input data comprising voice waveform data sampled at 16 kHz as a one-dimensional array, image data as a 224 by 224 pixel RGB tensor, text data as a token identifier sequence, and location data comprising latitude and longitude coordinates from a terminal device;
process the multimodal input data using the multilingual neural network model comprising a Transformer-based encoder-decoder architecture to generate localized content data in a plurality of languages;
determine, using the emotion identification model comprising a multimodal neural network integrating a convolutional neural network, a recurrent neural network, and a Transformer, an emotion label output as a probability distribution over a plurality of emotion categories, and adjust at least one of a content category, a display format, or a priority of the localized content data based on the emotion label;
configure, using the reinforcement learning model that receives device attribute data comprising a device type, an operating system type, a battery level, and an application type as input, access point parameters for a wireless access node comprising bandwidth allocation, channel selection, quality-of-service settings, and a transmission power level; and
transmit the localized content data to the terminal device via the communication interface and render the localized content data on a display device coupled to the circuitry.

19. The system according to claim 18, wherein the circuitry is further configured to estimate an emotion of a user by inputting the multimodal input data into the emotion identification model stored in the memory, and to adjust at least one of a method of generating the localized content data, a level of detail of the localized content data, or a display method of the localized content data based on the estimated emotion.

20. A method performed by circuitry of a system, the method comprising:
receiving, via a communication interface coupled to a packet-switched network, multimodal input data comprising at least voice waveform data and location data from a terminal device;
processing the multimodal input data using a multilingual neural network model comprising a Transformer-based encoder that receives the voice waveform data as a one-dimensional sampled array and generates a token sequence, and generating localized content data in a plurality of languages based on the token sequence and the location data;
determining, using an emotion identification model comprising a multimodal neural network integrating a convolutional neural network for image recognition and a recurrent neural network for voice feature extraction, an emotion label from the multimodal input data, the emotion label output as a probability distribution over a plurality of emotion categories; and
configuring access point parameters for a wireless access node based on device attribute data received from the terminal device, the access point parameters comprising at least bandwidth allocation and quality-of-service settings determined by a reinforcement learning model that receives the device attribute data and a connection history as input.
